(19) United States
(12) Patent Application Publication
(10) Pub. No.: US 2011/0210934 A1
(43) Pub. Date: Sep. 1, 2011

(54) TOUCH PANEL, AND INPUT DEVICE INCLUDING THE SAME

(75) Inventors: Bang-Won Lee, Yongin-si (KR); Chul-Yong Joung, Yongin-si (KR); Young-Ho Shin, Yongin-si (KR); Sang-Jin Lee, Yongin-si (KR)

(73) Assignee: ATLAB INC., Yongin-si (KR)

(21) Appl. No.: 13/125,238

(22) PCT Filed: Apr. 20, 2009
(86) PCT No.: PCT/KR09/02043

§ 371 Date: Apr. 20, 2011

(30) Foreign Application Priority Data
Nov. 11, 2008 (KR) 10-2008-0111799

(51) Int. Cl. G06F 3/041

(52) U.S. Cl. 345/173

(57) ABSTRACT

Provided are a touch panel and an input device. The touch panel includes a plurality of first touch pad groups disposed in a first direction and having a plurality of first touch pads disposed in the first direction and extending in a second direction. Here, the first touch pads disposed at the same position in the respective first touch pad groups are connected in common with a corresponding one of a plurality of first channels, a first input signal is applied to one of the first touch pads of each first touch pad group, and the first touch pads receiving the first input signal are connected with the first channels, respectively.

### TECHNICAL FIELD

The present invention relates to an input device, and more particularly, to a touch panel having a reduced number of touch sensors and a reduced number of channels and an input device having the touch panel.

### BACKGROUND ART

A touch panel is a device that is installed on the surface of a display, such as a cathode ray tube (CRT), liquid crystal display (LCD), plasma display panel (PDP) or electroluminescence (EL) display, and can detect a position touched by an object. The touch panel is installed in the screen of a display of a computer system or a portable information terminal so that a user can input information on the screen using his/her hand or a pen without a keyboard or mouse. In general, an input device having a touch panel includes a plurality of touch pads which have a specific pattern, and a plurality of touch sensors which are connected with the corresponding touch pads and output a touch signal indicating whether or not the corresponding touch pad is touched. Thus, the input device having a touch panel can detect a position touched by an object.

The touch pads may be formed on an indium tin oxide (ITO) (mixed oxide of indium and tin) film. The ITO film is widely used as a transparent electrode of display devices such as LCDs. Since the ITO film, which is a transparent conductive oxide thin film, has the advantages of high transparency, low sheet resistance, and ease in pattern formation, it is used as an electrode material in various other fields, such as organic light-emitting devices (OLEDs), solar cells, plasma displays, electronic papers (E-papers) as well as LCDs, and is also used in ITO ink and to block electromagnetic waves of CRT monitors.

Here, the input device having a touch panel must have an increased number of touch pads to improve resolution for detecting a touch position, and thus the number of touch sensors must also increase. For example, to obtain a resolution of 80×60, eighty x-axis touch pads and sixty y-axis touch pads are necessary, that is, the total of one hundred and forty touch sensors are necessary.

### DISCLOSURE

### Technical Problem

The present invention is directed to providing a touch panel which has high resolution using a small number of touch sensors.

The present invention is also directed to providing an input device having the touch panel.

### Technical Solution

One aspect of the present invention provides a first form of a touch panel including: a plurality of first touch pad groups disposed in a first direction and having a plurality of first touch pads disposed in the first direction and extending in a second direction. Here, the first touch pads disposed at the same position in the respective first touch pad groups are connected in common with a corresponding one of a plurality of first channels, a first input signal is applied to one of the first touch pads of each first touch pad group, and the first touch pads receiving the first input signal are connected with the first channels, respectively.

The first form of a touch panel may further include: a plurality of second touch pad groups disposed in the second direction and having a plurality of second touch pads disposed in the second direction and extending in the first direction. Here, the second touch pads disposed at the same position in the respective second touch pad groups may be connected in common with a corresponding one of a plurality of second channels, a second input signal may be applied to one of the second touch pads of each second touch pad group, and the second touch pads receiving the second input signal may be connected with the second channels, respectively.

A second form of a touch panel may include: a plurality of first touch pad groups disposed in a first direction, and having a plurality of first touch pads disposed in the first direction and extending in a second direction. Here, the first touch pads disposed at the same position in the respective first touch pad groups may be connected in common with a corresponding one of a plurality of first channels, a first input signal may be applied to one of the first touch pads of each first touch pad group, the first touch pads receiving the first input signal may be respectively connected with the first channels, and a second input signal may be applied to the first touch pads not receiving the first input signal.

The second form of a touch panel may further include: a plurality of second touch pad groups disposed in the second direction and having a plurality of second touch pads disposed in the second direction and extending in the first direction. Here, a third input signal may be applied to one of the second touch pads of each second touch pad group, a fourth input signal may be applied to the second touch pads not receiving the third input signal, the second touch pads disposed at the same position in the respective second touch pad groups may be connected in common with a corresponding one of a plurality of second channels, and the second touch pads receiving the third input signal may be respectively connected with the second channels.

A third form of a touch panel may include: a plurality of first electrodes disposed in a first direction and extending in a second direction; and a plurality of second electrodes each disposed between the first electrodes and extending in the second direction. Here, the second electrodes each may have a plurality of touch pads disposed in the second direction and a plurality of connection pads connecting the touch pads, one end of each first electrode may be connected with a first connection line, the first connection line may be connected between a first transmission channel and a first reception channel, one end of each second electrode may be connected with a second transmission channel, and the other end of each second electrode may be connected with a second reception channel.

In the third form of a touch panel, the one end of each second electrode may be connected with a second transmitting connection line, the other end of each second electrode may be connected with a second receiving connection line, the second transmitting connection line may be connected with the second transmission channel, and the second receiving connection line may be connected with the second reception channel. In the third form of a touch panel, the second transmitting channel may include a second odd transmission channel and a second even transmission channel, the second receiving channel may include a second odd reception channel and a second even reception channel, one end of each odd-numbered second electrode among the second electrodes may be connected with a second odd transmitting connection line, the other end of each odd-numbered second electrode may be connected with a second odd receiving connection line, one end of each even-numbered second electrode among the second electrodes may be connected with a second even transmitting connection line, the other end of each even-numbered second electrode may be connected with a second even receiving connection line, the second odd transmitting connection line may be connected with the second odd transmission channel, the second odd receiving connection line may be connected with the second odd reception channel, the second even transmitting connection line may be connected with the second even transmission channel, and the second even receiving connection line may be connected with the second even reception channel. In the third form of a touch panel, there may be a plurality of the second transmission channels and a plurality of the second reception channels, the one end of each second electrode may be connected with a corresponding one of the second transmission channels, and the other end of each second electrode may be connected with a corresponding one of the second reception channels.

In the third form of a touch panel, the second transmitting connection line and the second receiving connection line may be formed of a material having high conductivity. In the third form of a touch panel, the second odd transmitting connection line, the second even transmitting connection line, the second odd receiving connection line and the second even receiving connection line may be formed of a material having high conductivity.

In the third form of a touch panel, the first connection line may have a greater resistance than the first electrodes.

Another aspect of the present invention provides a first form of an input device including: a touch panel having a plurality of first touch pads disposed in a first direction and extending in a second direction and a plurality of first touch pad groups respectively disposed adjacent to the first touch pads in the first direction and having a plurality of second touch pads disposed in the first direction and extending in the second direction, and in which the first touch pads are respectively connected with corresponding first channels among a plurality of first channels and the second touch pads disposed at the same position in the respective first touch pad groups are connected in common with a corresponding one of a plurality of second channels; and a touch sensor unit for detecting whether or not the respective first touch pads are touched through the first channels and outputting a plurality of first touch signals indicating the touched first touch pad group in a first search mode operation, and detecting whether or not the second touch pads are touched through the second channels and outputting a plurality of second touch signals indicating a touched position in the first touch pad groups in a second search mode operation.

In the first form of an input device, the first touch pad groups may be respectively disposed on one side of the first touch pads, or the first touch pads may be respectively disposed in the corresponding first touch pad groups.

In the first form of an input device, the touch sensor unit may perform the first search mode operation and the second search mode operation in sequence, or simultaneously.

In the first form of an input device, the touch sensor unit may include: a first touch sensor connected with the first channels, detecting whether or not the first touch pads are touched and outputting the first touch signals in the first search mode operation; and a second touch sensor connected with the second channels, detecting whether or not the second touch pads are touched and outputting the second touch signals in the second search mode operation.

In the first form of an input device, the first touch sensor may detect impedances of the first touch pads varying according to whether or not the first touch pads are touched and determine whether or not the first touch pads are touched, and the second touch sensor may detect impedances of the second touch pads varying according to whether or not the second touch pads are touched and determine whether or not the second touch pads are touched.

In the first form of an input device, the first touch sensor of the touch sensor unit may include: a first input signal generator for generating a first input signal; a plurality of first sensing signal generators respectively connected with the first channels, receiving the first input signal, and delaying the first input signal according to whether or not the respective first touch pads are touched to respectively output a plurality of corresponding first sensing signals; a first reference signal generator for receiving the first input signal and outputting a first reference signal; and a plurality of first touch signal generators for detecting delay differences between the respective corresponding first sensing signals and the first reference signal to determine whether or not the respective first touch pads are touched, and respectively outputting the corresponding first touch signals.

In the first form of an input device, the first touch sensor of the touch sensor unit may output the first touch signals indicating that only one of the first touch pads having the lowest impedance is touched, or may output the first touch signals indicating that only the first touch pad corresponding to the first sensing signal having the largest delay difference from a first reference signal is touched.

In the first form of an input device, the second touch sensor of the touch sensor unit may include: a second input signal generator for generating a second input signal; a plurality of second sensing signal generators respectively connected with the second channels, receiving the second input signal, and delaying the second input signal according to whether or not the respective second touch pads are touched to respectively output a plurality of corresponding second sensing signals; a second reference signal generator for receiving the second input signal and outputting a second reference signal; and a plurality of second touch signal generators for detecting delay differences between the respective corresponding second sensing signals and the second reference signal to determine whether or not the respective second touch pads are touched, and respectively outputting the corresponding second touch signals.

The first form of an input device may further include a calculator for receiving the first touch signals and the second touch signals, calculating a touch position, and outputting a coordinate code corresponding to the touch position. The first form of an input device may further include a calculator for successively receiving the second touch signals, comparing the successively-received second touch signals to detect a movement direction, and outputting scroll information.

In the first form of an input device, when there are a plurality of the touch positions, the calculator may calculate the middle of the touch positions and output the coordinate code corresponding to the middle.

In the first form of an input device, the touch panel may further include: a plurality of third touch pads disposed in the second direction and extending in the first direction; and a plurality of second touch pad groups disposed adjacent to the respective third touch pads in the second direction and having a plurality of fourth touch pads disposed in the second direction and extending in the first direction. Here, the third touch pads may be respectively connected with corresponding third channels among a plurality of third channels, and the fourth touch pads disposed at the same position in the respective second touch pad groups may be connected in common with a corresponding one of a plurality of fourth channels. In the first form of an input device, the touch sensor unit may additionally detect whether or not the respective third touch pads are touched through the third channels and additionally output a plurality of third touch signals indicating the touched second touch pad group in the first search mode operation, and may additionally detect whether or not the fourth touch pads are touched through the fourth channels and additionally output a plurality of fourth touch signals indicating a touched position in the second touch pad groups in the second search mode operation. In the first form of an input device, the touch sensor unit may include: a third touch sensor for detecting whether or not the respective third touch pads are touched through the respective third channels and outputting a plurality of third touch signals indicating the touched second touch pad group in the first search mode operation; and a fourth touch sensor for detecting whether or not the fourth touch pads are touched through the fourth channels and outputting a plurality of fourth touch signals indicating a touched position in the second touch pad groups in the second search mode operation.

In the first form of an input device, the second touch pad groups may be respectively disposed on one side of the third touch pads, or the third touch pads may be respectively disposed in the corresponding second touch pad groups.

Yet another aspect of the present invention provides a second form of an input device including: a touch panel having a plurality of first touch pad groups disposed in a first direction and having a plurality of first touch pads disposed in the first direction and extending in a second direction, and in which the first touch pads disposed at the same position in the respective first touch pad groups are connected in common with a corresponding one of a plurality of first channels, a first input signal is applied to one of the first touch pads in each first touch pad group, and the first touch pads receiving the first input signal are respectively connected with the first channels; and a touch sensor unit for outputting the first input signal to the touch panel, detecting whether or not the respective first touch pads receiving the first input signal are touched through the first channels and outputting first touch signals indicating the touched first touch pad group in a first search mode operation, and detecting whether or not the first touch pads are touched through the first channels and outputting second touch signals indicating a touched position in the first touch pad groups in a second search mode operation.

In the second form of an input device, the touch sensor unit may include: a first touch sensor for outputting the first input signal, detecting whether or not the first touch pads receiving the first input signal are touched through the first channels and outputting the first touch signals in the first search mode operation; and a second touch sensor for determining whether or not the first touch pads are touched through the first channels and outputting the second touch signals in the second search mode operation.

In the second form of an input device, the second touch sensor may determine whether or not the first touch pads are touched by detecting impedances of the first touch pads varying according to whether or not the first touch pads are touched.

In the second form of an input device, the first touch sensor may include: a first input signal generator for outputting the first input signal; and a plurality of first touch signal generators for receiving the first input signal and a plurality of corresponding first delay signals respectively input through the plurality of first channels, detecting delay differences between the first input signal and the respective corresponding first delay signals to determine whether or not the first touch pads are touched, and outputting the corresponding first touch signals.

In the second form of an input device, the first touch sensor may output the first touch signals indicating that only the first touch pad corresponding to the first delay signal having the largest delay difference from the first input signal is touched.

In the second form of an input device, the first touch signal generators of the first touch sensor each may include: a delay signal detector for receiving the corresponding first delay signal, detecting a level of the corresponding first delay signal, and outputting a pulse delay signal; and a comparator for receiving the first input signal and the pulse delay signal, detecting a delay difference between the first input signal and the pulse delay signal to determine whether or not the corresponding first touch pad is touched, and outputting the corresponding first touch signal.

In the second form of an input device, the second touch sensor may include: a second input signal generator for generating a second input signal; a plurality of second sensing signal generators respectively connected with the first channels, receiving the second input signal, and delaying the second input signal according to whether or not the respective first touch pads are touched to respectively output a plurality of corresponding second sensing signals; a second reference signal generator for receiving the second input signal and outputting a second reference signal; and a plurality of second touch signal generators for detecting delay differences between the respective corresponding second sensing signals and the second reference signal to determine whether or not the respective first touch pads are touched, and respectively outputting the corresponding second touch signals.

In the second form of an input device, the touch sensor unit may further include a controller for outputting a control signal driving the first touch sensor in the first search mode operation and driving the second touch sensor in the second search mode operation.

The second form of an input device may further include a calculator for receiving the first touch signals and the second touch signals, calculating a touch position, and outputting a coordinate code corresponding to the touch position. The second form of an input device may further include a calculator for successively receiving the second touch signals, comparing the successively-received second touch signals to detect a movement direction, and outputting scroll information.

In the second form of an input device, when there are a plurality of the touch positions, the calculator may calculate the middle of the touch positions and outputs the coordinate code corresponding to the middle.

In the second form of an input device, the touch panel may further have a plurality of second touch pad groups disposed in the second direction and having a plurality of second touch pads disposed in the second direction and extending in the first direction, the second touch pads disposed at the same position in the respective second touch pad groups may be connected in common with a corresponding one of a plurality of second channels, a third input signal may be applied to one of the second touch pads in each second touch pad group, and the second touch pads receiving the third input signal may be respectively connected with the second channels. In the second form of an input device, the touch sensor unit may further have: a third touch sensor for outputting the third input signal, detecting whether or not the respective second touch pads receiving the third input signal are touched through the second channels and outputting a plurality of third touch signals indicating the touched second touch pad group in the first search mode operation; and a fourth touch sensor for detecting whether or not the second touch pads are touched through the second channels and outputting a plurality of fourth touch signals indicating a touched position in the second touch pad groups in the second search mode operation.

A third form of an input device may include: a touch panel having a plurality of first touch pad groups disposed in a first direction and having a plurality of first touch pads disposed in the first direction and extending in a second direction, and in which the first touch pads disposed at the same position in the respective first touch pad groups are connected in common with a corresponding one of a plurality of first channels, a first input signal is applied to one of the first touch pads in each first touch pad group, the first touch pads receiving the first input signal are respectively connected with the first channels, and a second input signal is applied to the first touch pads not receiving the first input signal; and a touch sensor unit for outputting the first input signal to the touch panel, detecting whether or not the respective first touch pads receiving the first input signal are touched through the first channels and outputting first touch signals indicating the touched first touch pad group in a first search mode operation, and outputting the first input signal and the second input signal, determining whether or not the respective first touch pads are touched through the first channels and outputting second touch signals indicating a touched position in the first touch pad groups in a second search mode operation.

In the third form of an input device, the touch sensor unit may include: an input signal generator for outputting an input signal; a controller for receiving the input signal, outputting the input signal as the first input signal in the first search mode operation, outputting the input signal as the first input signal and the second input signal in the second search mode operation, and outputting a control signal; a plurality of touch signal generators respectively connected with the first channels, receiving the input signal and a plurality of corresponding delay signals input through the first channels, detecting delay differences between the input signal and the respective corresponding delay signals to determine whether or not the first touch pads are touched, and outputting a plurality of corresponding touch signals; and an output unit for receiving the touch signals, and, in response to the control signal, outputting the touch signals as the first touch signals in the first search mode operation and as the second touch signals in the second search mode operation.

In the third form of an input device, the touch sensor unit may output the first touch signals indicating that only the first touch pad corresponding to the delay signal having the largest delay difference from the input signal is touched in the first search mode operation.

In the third form of an input device, the touch signal generators of the touch sensor unit each may include: a delay signal detector for receiving the corresponding delay signal, detecting a level of the corresponding delay signal, and outputting a pulse delay signal; and a comparator for receiving the input signal and the pulse delay signal, detecting a delay difference between the input signal and the pulse delay signal to determine whether or not the corresponding first touch pad is touched, and outputting the corresponding touch signal among the touch signals.

The third form of an input device may further include a calculator for receiving the first touch signals and the second touch signals, calculating a touch position, and outputting a coordinate code corresponding to the touch position. The third form of an input device may further include a calculator for successively receiving the second touch signals, comparing the successively-received second touch signals to detect a movement direction, and outputting scroll information.

In the third form of an input device, when there are a plurality of the touch positions, the calculator may calculate the middle of the touch positions and output the coordinate code corresponding to the middle.

In the third form of an input device, the touch panel may further include a plurality of second touch pad groups disposed in the second direction and having a plurality of second touch pads disposed in the second direction and extending in the first direction, a third input signal may be applied to one of the second touch pads in each second touch pad group, a fourth input signal may be applied to the second touch pads not receiving the third input signal, the second touch pads disposed at the same position in the respective second touch pad groups may be connected in common with a corresponding one of a plurality of second channels, and the second touch pads receiving the third input signal may be respectively connected with the second channels. In the third form of an input device, the touch sensor unit may further include: a second touch sensor for outputting the third input signal, detecting whether or not the respective second touch pads receiving the third input signal are touched through the second channels and outputting a plurality of third touch signals indicating the touched second touch pad group in the first search mode operation, and outputting the third input signal and the fourth input signal, detecting whether or not the respective second touch pads are touched through the second channels and outputting a plurality of fourth touch signals indicating a touched position in the second touch pad groups in the second search mode operation.

The first, second and third forms of an input device may further include a calculator for receiving the first touch signals and the second touch signals to calculate a touch position in the first direction, receiving the third touch signals and the fourth touch signals to calculate a touch position in the second direction, and outputting a coordinate code corresponding to the touch position in the first direction and the touch position in the second direction.

Still another aspect of the present invention provides a fourth form of an input device including: a touch panel having a plurality of first electrodes disposed in a first direction and extending in a second direction and a plurality of second electrodes each disposed between the first electrodes and extending in the second direction, and in which the second electrodes each have a plurality of touch pads disposed in the second direction and a plurality of connection pads connecting the touch pads, one end of each first electrode is connected with a first connection line, the first connection line is connected between a first transmission channel and a first reception channel, one end of each second electrode is connected with a second transmission channel, and the other end of each second electrode is connected with a second reception channel; a first touch sensor unit for outputting a first input signal through the first transmission channel, detecting a first delay difference between the first input signal and a first delay signal input through the first reception channel and outputting a first coordinate in a first search mode operation; and a second touch sensor unit for outputting a second input signal through the second transmission channel, detecting a second delay difference between the second input signal and a second delay signal input through the second reception channel, and outputting a second coordinate in a second search mode operation.

In a first form of a touch panel of the fourth form of an input device, the one end of each second electrode may be connected with a second transmitting connection line, the other end of each second electrode may be connected with a second receiving connection line, the second transmitting connection line may be connected with the second transmission channel, and the second receiving connection line may be connected with the second reception channel. In a second form of a touch panel of the fourth form of an input device, the second transmission channel may include a second odd transmission channel and a second even transmission channel, the second reception channel may include a second odd reception channel and a second even reception channel, one end of each odd-numbered second electrode may be connected with a second odd transmitting connection line, the other end of each odd-numbered second electrode may be connected with a second odd receiving connection line, one end of each even-numbered second electrode may be connected with a second even transmitting connection line, the other end of each even-numbered second electrode may be connected with a second even receiving connection line, the second odd transmitting connection line may be connected with the second odd transmission channel, the second odd receiving connection line may be connected with the second odd reception channel, the second even transmitting connection line may be connected with the second even transmission channel, and the second even receiving connection line may be connected with the second even reception channel. In a third form of a touch panel of the fourth form of an input device, there may be a plurality of the second transmission channels and a plurality of the second reception channels, the one end of each second electrode may be connected with a corresponding one of the second transmission channels, and the other end of each second electrode may be connected with a corresponding one of the second reception channels.

In the first form of a touch panel of the fourth form of an input device, the second transmitting connection line and the second receiving connection line may be formed of a material having high conductivity. In the second form of a touch panel, the second odd transmitting connection line, the second even transmitting connection line, the second odd receiving connection line and the second even receiving connection line may be formed of a material having high conductivity.

In the fourth form of an input device, the first touch sensor unit may output a first additional input signal through the first reception channel, receive a first additional delay signal input through the first transmission channel, detect a first additional delay difference between the first additional input signal and the first additional delay signal and output the first coordinate using the first delay difference and the first additional delay difference in the first search mode operation.

In the fourth form of an input device, a first form of the second touch sensor unit may output a second additional input signal through the second reception channel, receive a second additional delay signal input through the second transmission channel, detect a second additional delay difference between the second additional input signal and the second additional delay signal and output the second coordinate using the second delay difference and the second additional delay difference in the second search mode operation. A second form of the second touch sensor unit may include: a second odd touch sensor for outputting a second odd input signal through the second odd transmission channel, receiving a second odd delay input signal through the second odd reception channel, detecting a delay difference between the second odd input signal and the second odd delay input signal, and outputting a second odd coordinate; a second even-number touch sensor for outputting a second even input signal through the second even transmission channel, receiving a second even delay input signal through the second even reception channel, detecting a delay difference between the second even input signal and the second even delay input signal, and outputting a second even coordinate; and an output unit for receiving the second odd coordinate and the second even coordinate and outputting the middle of the second odd coordinate and the second even coordinate as the second coordinate. A third form of the second touch sensor unit may output the second input signal through the second transmission channel corresponding to the first coordinate among the second transmission channels and receive the second delay signal through the second reception channel corresponding to the first coordinate among the second reception channels in the second search mode operation.

In the fourth form of an input device, the first touch sensor unit may output a first additional input signal through the first reception channel, receive a first additional delay signal input through the first transmission channel, detect a first additional delay difference between the first additional input signal and the first additional delay signal and output the first coordinate using the first delay difference and the first additional delay difference in the first search mode operation. In the fourth form of an input device, the second touch sensor unit may output a second additional input signal through the second reception channel corresponding to the first coordinate, receive a second additional delay signal input through the second transmission channel corresponding to the first coordinate, detect a second additional delay difference between the second additional input signal and the second additional delay signal and output the second coordinate using the second delay difference and the second additional delay difference in the second search mode operation.

The fourth form of an input device may perform the first search mode operation and the second search mode operation in sequence or simultaneously.

In the fourth form of an input device, the first connection line may have a greater resistance than the first electrodes.

### Advantageous Effects

A touch panel and input device having the touch panel according to exemplary embodiments of the present invention can detect a touch position using a small number of channels and a small number of touch sensors.

### DESCRIPTION OF DRAWINGS

FIGS. 1 and 2 are diagrams for illustrating the concept of the present invention.

FIG. 3 is a block diagram of an input device having a touch panel according to an exemplary embodiment of the present invention.

FIG. 4 illustrates an exemplary embodiment of the touch panel of the input device shown in FIG. 3.

FIG. 5 illustrates an exemplary embodiment of a touch sensor unit of the input device shown in FIG. 3.

FIG. 6 is a block diagram of an input device having a touch panel according to another exemplary embodiment of the present invention.

FIG. 7 illustrates an exemplary embodiment of the touch panel of the input device shown in FIG. 6.

FIG. 8 illustrates an exemplary embodiment of a touch sensor unit of the input device shown in FIG. 6.

FIGS. 9 to 12 are diagrams for illustrating operation of the input device shown in FIG. 6.

FIG. 13 is a block diagram of an input device having a touch panel according to yet another exemplary embodiment of the present invention.

FIG. 14 illustrates an exemplary embodiment of the touch panel of the input device shown in FIG. 13.

FIG. 15 illustrates an exemplary embodiment of a touch sensor unit of the input device shown in FIG. 13.

FIGS. 16 to 19 are diagrams for illustrating operation of the input device shown in FIG. 13.

FIGS. 20 and 21 are diagrams for illustrating a scroll operation of an input device having a touch panel according to an exemplary embodiment of the present invention.

FIGS. 22 to 24 show exemplary embodiments of a touch panel of an input device of the present invention.

FIG. 25 illustrates a first form of a touch panel according to another exemplary embodiment of the present invention.

FIG. 26 is a block diagram of an exemplary embodiment of a touch sensor of an input device having the touch panel shown in FIG. 25.

FIG. 27 illustrates a second form of a touch panel according to another exemplary embodiment of the present invention.

FIG. 28 illustrates a third form of a touch panel according to another exemplary embodiment of the present invention.

### MODES OF THE INVENTION

Hereinafter, exemplary embodiments of the present invention will be described in detail. However, the present invention is not limited to the exemplary embodiments disclosed below, but can be implemented in various forms. The following exemplary embodiments are described in order to enable those of ordinary skill in the art to embody and practice the invention.

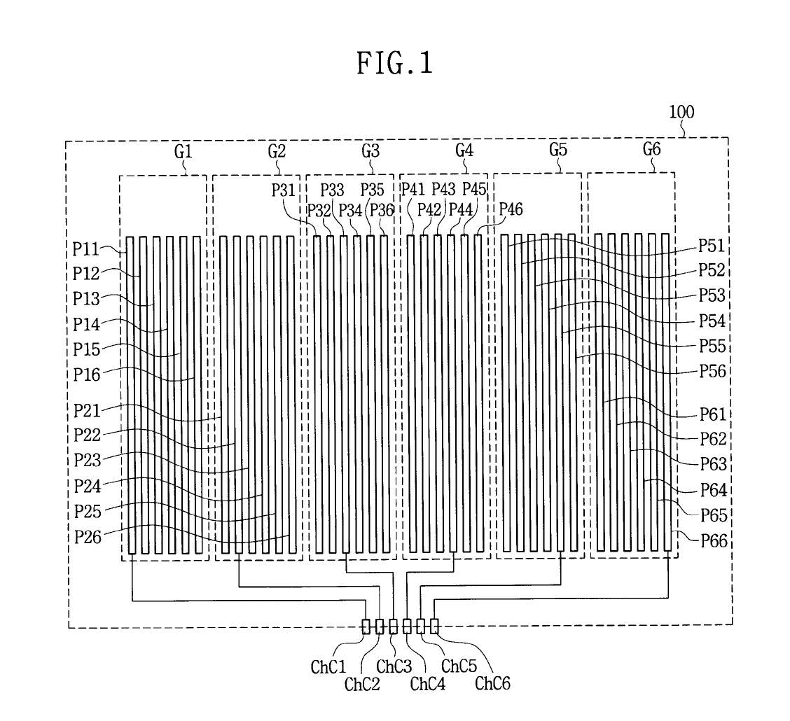

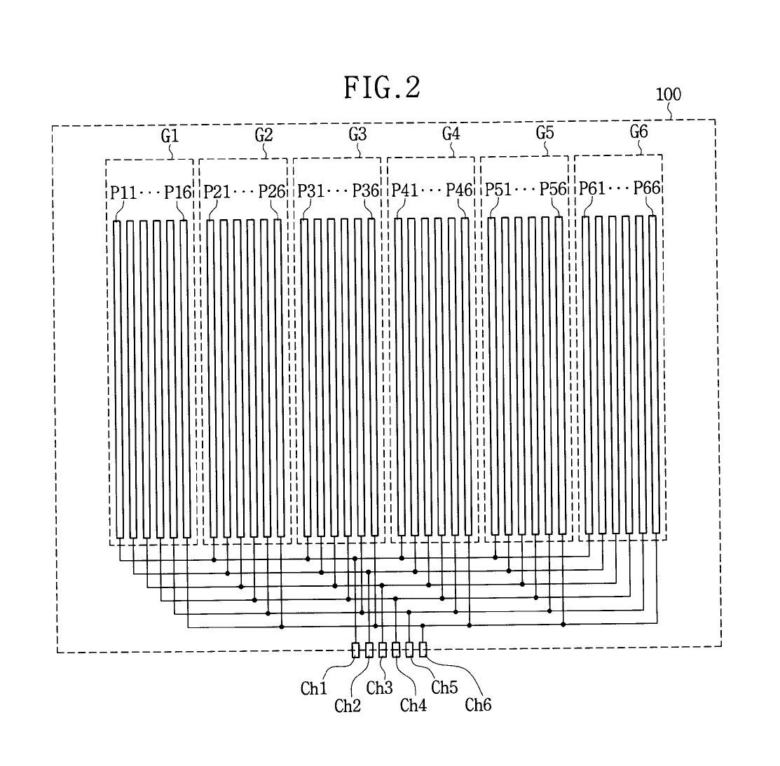

FIGS. 1 and 2 show a constitution of a touch panel 100 according to an exemplary embodiment of the present invention to describe the concept of the present invention. The touch panel 100 may include six touch pad groups G1 to G6, each of the touch pad groups G1 to G6 may include six touch pads P11 to P16, P21 to P26, . . . , and P61 to P66, and the touch pads may be connected with corresponding first channels ChC1 to ChC6 and/or second channels Ch1 to Ch6, respectively. As mentioned above, the touch panel 100 may be formed on an indium tin oxide (ITO) film. The first channels ChC1 to ChC6 and the second channels Ch1 to Ch6 may be formed as bonding pads, respectively. Although not shown in the drawings, the first channels ChC1 to ChC6 and the second channels Ch1 to Ch6 may be connected with touch sensors, respectively. FIGS. 1 and 2 illustrate a case in which the touch panel 100 includes six touch pad groups and the touch pad groups each include six touch pads, but the number of touch pad groups and the number of touch pads can be increased or reduced. Here, channel means touch sensing input port and touch sensor means integrated circuit or its related circuit block. Since touch sensor has a limited number of pins, the number of channels should not be equal to that of touch sensors.

The concept of the present invention will be described below with reference to FIGS. 1 and 2.

FIG. 1 is a diagram for illustrating a first search mode operation. In the first search mode operation, an input device having a touch panel according to an exemplary embodiment of the present invention may detect whether or not one touch pad P11, P22, P33, P44, P55 and P66 of touch pads constituting each touch pad group G1 to G6 is touched. In other words, the touch pads P11, P22, P33, P44, P55 and P66 may be respectively connected with the corresponding first channels ChC1, ChC2, ChC3, ChC4, ChC5 and ChC6, and touch sensors (not shown) of a touch sensor unit (not shown) may be respectively connected with the corresponding first channels ChC1 to ChC6 and detect whether or not the touch pads P11, P22, P33, P44, P55 and P66 are touched through the first channels ChC1 to ChC6. Thus, the input device having the touch panel according to an exemplary embodiment of the present invention determines to which one of the touch pad groups G1 to G6 a touch position corresponds in the first search mode operation.

FIG. 2 is a diagram for illustrating a second search mode operation. In the second search mode operation, the input device having the touch panel according to an exemplary embodiment of the present invention may detect which touch pad an object touches in the touch pad groups G1 to G6. In other words, in the input device having the touch panel according to an exemplary embodiment of the present invention, the touch pads (P11, P21, . . . , and P61), (P12, P22, . . . , and P62), . . . , and (P16, P26, . . . , and P66) disposed at the corresponding position among the touch pads constituting the respective touch pad groups G1 to G6 are connected in common with each second channel Ch1 to Ch6. In addition, the second channels Ch1 to Ch6 may be connected with the corresponding touch sensors (not shown), respectively. Thus, the input device having the touch panel according to an exemplary embodiment of the present invention determines a touch position in the respective touch pad groups G1 to G6 in the second search mode operation. Although FIG. 2 shows that the touch pads (P11, P21, . . . , and P61), (P12, P22, . . . , and P62), . . . , and (P16, P26, . . . , and P66) disposed at the corresponding position are connected in one line and connected in common with each corresponding second channel Ch1 to Ch6, the touch pads (P11, P21, . . . , and P61), (P12, P22, . . . , and P62), . . . , and (P16, P26, . . . , and P66) disposed at the corresponding position may be connected with the second channels Ch1 to Ch6 through six additional signal lines.

As described above, the input device having the touch panel according to an exemplary embodiment of the present invention performs the first search mode operation and the second search mode operation to detect a touch position. As illustrated in FIG. 1, the first search mode operation may be performed using a structure in which each first channel ChC1 to ChC6 is connected with one of the touch pads constituting each touch pad group G1 to G6, and as illustrated in FIG. 2, the second search mode operation may be performed using a structure in which each second channel Ch1 to Ch6 is connected with touch pads disposed at the corresponding position among the touch pads constituting the touch pad groups G1 to G6.

FIGS. 1 and 2 illustrate a case in which the touch pads P11, P22, P33, P44, P55 and P66 connected with the respective first channels ChC1 to ChC6 are connected with the corresponding second channels Ch1 to Ch6, but an input device having a touch panel according to an exemplary embodiment of the present invention may have additional touch pads connected with only the respective first channels ChC1 to ChC6. In this case, the additional touch pads connected with only the respective first channels ChC1 to ChC6 may be disposed on one side of the corresponding groups G1 to G6 or in the corresponding groups G1 to G6. In addition, the first channels ChC1 to ChC6 may be the second channels Ch1 to Ch6. Furthermore, FIGS. 1 and 2 illustrate a case in which the touch pads (P11, P12, . . . , P16), (P21, P22, . . . , P26), . . . , and (P61, P62, . . . , P66) are connected with the corresponding first channels ChC1 to ChC6 and the corresponding second channels Ch1 to Ch6, but a touch panel and input device having the touch panel according to exemplary embodiments of the present invention may be configured so that the first channels ChC1 to ChC6 and the second channels Ch1 to Ch6 are respectively connected with pins of a semiconductor device or element, and the touch pads (P11, P12, . . . , P16), (P21, P22, . . . , P26), . . . , and (P61, P62, . . . , P66) are connected with the corresponding first channels ChC1 to ChC6 or the corresponding second channels Ch1 to Ch6 at appropriate times in the semiconductor device or element.

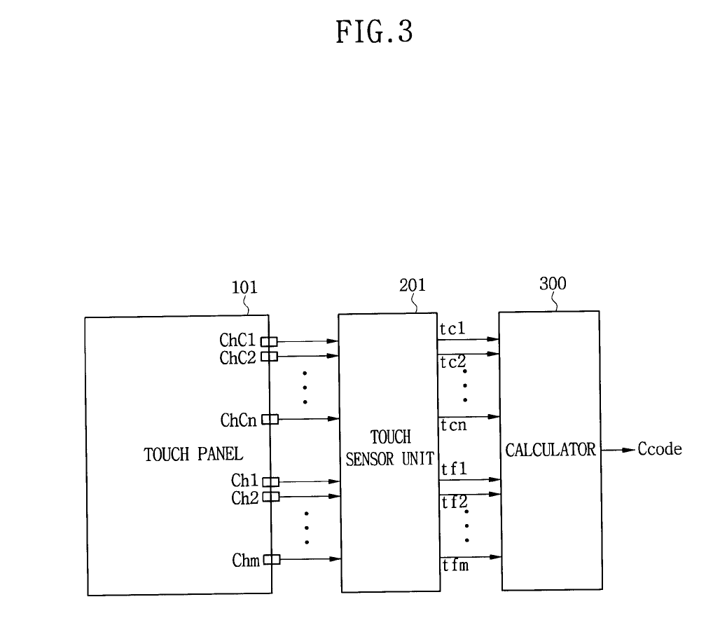

FIG. 3 is a block diagram of an input device having a touch panel according to an exemplary embodiment of the present invention. The input device may include a touch panel 101, a touch sensor unit 201, and a calculator 300.

Functions of the blocks shown in FIG. 3 will be described below.

The touch panel 101 includes a plurality of first touch pads (not shown) and a plurality of second touch pads (not shown), and each touch pad may be used for detecting an impedance (e.g. capacitance) varying according to whether or not an object is touched. As mentioned above, the touch pads may be formed on an ITO film. The first touch pads may be respectively connected with corresponding first channels ChC1 to ChCn, the second touch pads may be respectively connected with corresponding second channels Ch1 to Chm, and the first channels ChC1 to ChCn and the second channels Ch1 to Chm may be formed to have bonding pads. In addition, the second touch pads are divided into a plurality of touch pad groups.

The touch sensor unit 201 is connected with the first channels ChC1 to ChCn and the second channels Ch1 to Chm. The touch sensor unit 201 determines whether or not an object touches the first touch pads through the first channels ChC1 to ChCn to output first touch signals tc1 to tcn, and determines whether or not an object touches the second touch pads through the second channels Ch1 to Chm to output second touch signals tf1 to tfm. The first touch signals tc1 to tcn indicate which touch pad group an object touches, and the second touch signals tf1 to tfm indicate at which position a touch pad touched by the object is in the touch pad groups.

The calculator 300 may receive the first touch signals tc1 to tcn and the second touch signals tf1 to tfm and calculate and output a coordinate code Ccode of a touched position. The calculator 300 may increase the resolution of the input device using interpolation. More specifically, when a plurality of positions are touched, the calculator 300 may calculate the center of the touched positions and output the coordinate code Ccode corresponding to the calculated center. In addition, the calculator 300 may successively receive the second touch signals tf1 to tfm, compare the successively received second touch signals tf1 to tfm, and output scroll information.

Although not shown in the drawings, the input device having a touch panel according to an exemplary embodiment of the present invention may not include the calculator 300. In this case, the input device having a touch panel outputs the first touch signals tc1 to tcn and the second touch signals tf1 to tfm.

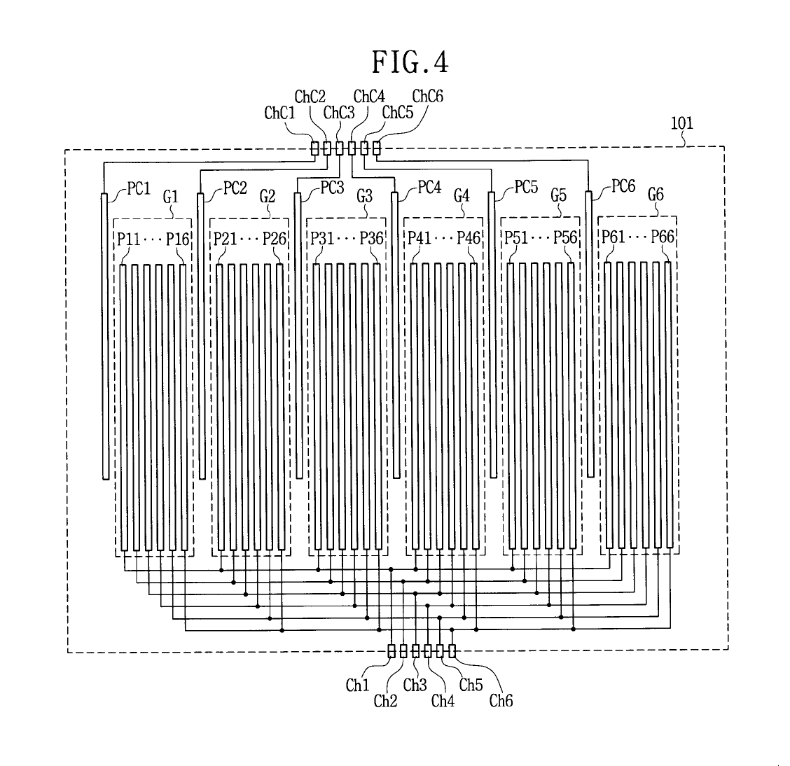

FIG. 4 illustrates an exemplary embodiment of the touch panel 101 of the input device shown in FIG. 3. The touch panel 101 may include six first touch pads PC1 to PC6 and six touch pad groups G1 to G6. The six touch pad groups G1 to G6 may each include six second touch pads (P11 to P16), (P21 to P26), . . . , and (P61 to P66).

The first touch pads PC1 to PC6 may be disposed in a first direction (e.g., the direction of the x-axis) and extend in a second direction (e.g., the direction of the y-axis), and the second touch pads (P11 to P16), (P21 to P26), . . . , and (P61 to P66) may be also disposed in the first direction (e.g., the direction of the x-axis) and extend in the second direction (e.g., the direction of the y-axis). In addition, the touch pad groups G1 to G6 may be disposed adjacent to the first touch pads PC1 to PC6, respectively.

The first touch pads PC1 to PC6 may be respectively connected with the corresponding first channels ChC1 to ChC6, and the second touch pads (P11, P21, . . . , and P61), (P12, P22, . . . , and P62), . . . , and (P16, P26, . . . , and P66) disposed at the same position in the touch pad groups G1 to G6 are connected in common with each corresponding second channel Ch1 to Ch6. As mentioned above, the second touch pads (P11, P21, . . . , and P61), (P12, P22, . . . , and P62), . . . , and (P16, P26, . . . , and P66) disposed at the same position in the touch pad groups G1 to G6 may be connected with the corresponding second channels Ch1 to Ch6 through six additional signal lines.

FIG. 4 shows a case in which the touch pad groups G1 to G6 are respectively disposed at one side of the first touch pads PC1 to PC6, but the first touch pads PC1 to PC6 may be respectively disposed in the corresponding touch pad groups G1 to G6.

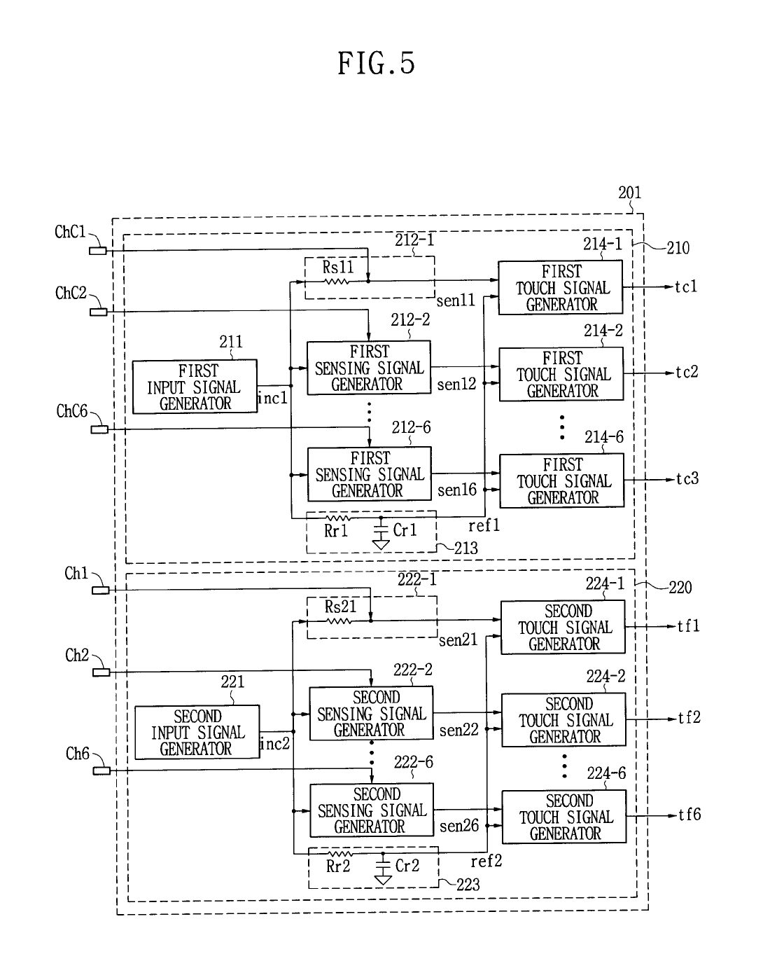

FIG. 5 illustrates an exemplary embodiment of the touch sensor unit 201 of the input device shown in FIG. 3. The touch sensor unit 201 may include a first touch sensor 210 and a second touch sensor 220. The first touch sensor 210 may include a first input signal generator 211, six first sensing signal generators 212-1 to 212-6, a first reference signal generator 213 and six first touch signal generators 214-1 to 214-6, and the second touch sensor 220 may include a second input signal generator 221, six second sensing signal generators 222-1 to 222-6, a second reference signal generator 223 and six second touch signal generators 224-1 to 224-6. In addition, the first channels ChC1 to ChC6 may be connected with the corresponding first sensing signal generators 212-1 to 212-6, and the second channels Ch1 to Ch6 may be connected with the corresponding second sensing signal generators 222-1 to 222-6.

Functions of the blocks shown in FIG. 5 will be described below.

In a first search mode operation, the first touch sensor 210 may determine whether or not the first touch pads PC1 to PC6 are touched through the first channels ChC1 to ChC6 and output the first touch signals tc1 to tc6, and in a second search mode operation, the second touch sensor 220 may determine whether or not the second touch pads P11 to P66 are touched through the second channels Ch1 to Ch6 and output the second touch signals tf1 to tf6.

The first input signal generator 211 and the second input signal generator 221 may output a first input signal inc1 and a second input signal inc2, respectively. The first and second input signals inc1 and inc2 may be clock signals.

The six first sensing signal generators 212-1 to 212-6 may be respectively connected with the corresponding first channels ChC1 to ChC6, delay the first input signal inc1 according to whether or not the first touch pads PC1 to PC6 are touched, and output first sensing signals sen11 to sen16. The six second sensing signal generators 222-1 to 222-6 may be respectively connected with the corresponding second channels Ch1 to Ch6, delay the second input signal inc2 according to whether or not the second touch pads P11 to P66 are touched, and output second sensing signals sen21 to sen26.

The first reference signal generator 213 and the second reference signal generator 223 may delay the first input signal inc1 and the second input signal inc2 for a specific time regardless of whether or not the touch pads are touched, and output a first reference signal ref1 and a second reference signal ref2, respectively. If the first and second reference signal generators 213 and 223 respectively delay the first and second input signals inc1 and inc2 for a specific time and output the first and second reference signals ref1 and ref2, it is possible to more accurately determine whether or not the touch pads are touched. However, the first reference signal generator 213 and the second reference signal generator 223 may be configured to output the first and second input signals inc1 and inc2 as the first and second reference signals ref1 and ref2 without delaying them.

The first touch signal generators 214-1 to 214-6 may receive the first reference signal ref1 and the corresponding first sensing signals sen11 to sen16, determine whether or not the corresponding first touch pads PC1 to PC6 are touched, and output the first touch signals tc1 to tc6 indicating whether or not the first touch pads PC1 to PC6 are touched. The second touch signal generators 224-1 to 224-6 may receive the second reference signal ref2 and the corresponding second sensing signals sen21 to sen26, determine whether or not the corresponding second touch pads P11 to P66 are touched, and output the second touch signals tf1 to tf6 indicating whether or not the second touch pads P11 to P66 are touched.

The first touch signal generators 214-1 to 214-6 may determine that the corresponding first touch pads PC1 to PC6 are touched when the corresponding first sensing signals sen11 to sen16 are received after the first reference signal ref1, and determine that the corresponding first touch pads PC1 to PC6 are not touched when the first reference signal ref1 is received after the corresponding first sensing signals sen11 to sen16.

In addition, the first touch signal generators 214-1 to 214-6 may output delay differences between the respective corresponding first sensing signals sen11 to sen16 and the first reference signal ref1. In this case, the first touch signals tc1 to tc6 may be signals corresponding to the delay differences (e.g., signals having voltages corresponding to the delay differences, or thermometer code or binary code signals indicating the delay differences). In addition, the first touch signal generators 214-1 to 214-6 may have delay detectors (not shown) which detect delay differences between the first sensing signals sen11 to sen16 and the first reference signal ref1 and between the second sensing signals sen21 to sen26 and the second reference signal ref2 and output signals corresponding to the delay differences, and output units (not shown) which receive the signals corresponding to the delay differences and output touch signals indicating whether or not the first touch pads PC1 to PC6 are touched. In this case, the first touch signal generators 214-1 to 214-6 may determine that the first touch pads PC1 to PC6 are touched when the delay differences are a specific time or more. The second touch signal generators 224-1 to 224-6 may determine whether or not the second touch pads P11 to P66 are touched in the same way as the first touch signal generators 214-1 to 214-6.

Furthermore, the first touch sensor 210 and the second touch sensor 220 may make only one of the first touch signals tc1 to tc6 and one of the second touch signals tf1 to tf6 indicate the touched state, respectively. For example, even if it is determined that none of the first touch pads PC1 to PC6 are touched, the first touch sensor 210 may make only a first touch signal corresponding to a first sensing signal having the largest delay among the first sensing signals sen11 to sen16 indicate the touched state. In addition, when it is determined that two or more of the first touch pads PC1 to PC6 are touched, the first touch sensor 210 may make a first touch signal corresponding to a first sensing signal having the largest delay among the first sensing signals sen11 to sen16 indicate the touched state, or may make only a first touch signal corresponding to one of the first touch pads PC1 to PC6 determined to be touched indicate the touched state according to a previously determined rule. These are the same for the second touch sensor 220.

FIG. 4 shows a case in which the touch panel 101 includes six first touch pads and six touch pad groups and the touch pad groups each include six second touch pads, but the number of the first touch pads, the number of the touch pad groups and the number of the second touch pads can be increased or reduced. In this case, the number of the first sensing signal generators and the number of the second sensing signal generators are also increased or reduced.

In addition, the touch sensor unit 201 shown in FIG. 5 detects delay differences between the first reference signal ref1 and the first sensing signals sen11 to sen16 and between the second reference signal ref12 and the second sensing signals sen21 to sen26 to determine whether or not the corresponding touch pads are touched, but the first touch sensor 210 and/or the second touch sensor 220 of the touch sensor unit 201 may detect impedances (e.g. capacitances) of touch pads varying according to whether or not the touch pads are touched.

Operation of the input device having a touch panel according to the exemplary embodiment of the present invention will be described below with reference to FIGS. 3 to 5.

First, in the first search mode operation, the first touch sensor 210 of the touch sensor unit 201 may determine which one of the first touch pads PC1 to PC6 is touched. When an object touches only the first touch pad PC2, the first sensing signal generator 212-2 delays the first input signal inc1 due to the capacitance of the object and/or the resistance of the first touch pad PC2 to output the first sensing signal sen12, and the other first sensing signal generators 212-1 and 212-3 to 212-6 output the second sensing signals sen11 and sen13 to sen16 with delaying the first input signal inc1 smaller than the first reference signal ref1, respectively. Thus, the first touch signal generator 214-2 outputs the first touch signal tc2 indicating the touched sate, and the other first touch signal generators 214-1 and 214-3 to 214-6 output the first touch signals tc1 and tc3 to tc6 indicating a non-touched state, respectively.

As described above, when it is determined that none of the first touch pads PC1 to PC6 are directly touched, but any touch pad of the second touch pads (P11 to P16), (P21 to P26), . . . , and (P61 to P66) in the touch pad groups G1 to G6 is touched, the first touch sensor 210 may make only a first touch signal corresponding to a first sensing signal having the largest delay indicate the touched state. In addition, when two or more of the first touch pads PC1 to PC6 are touched, the first touch sensor 210 may make only a first touch signal corresponding to a first sensing signal having the largest delay among first sensing signals corresponding to the touched first touch pads indicate the touched state, or may make only one first touch signal (e.g., when it is determined that two of the first touch pads are touched in the touch panel of FIG. 4, a first touch signal corresponding to the first touch pad on the left side) indicate the touched state according to a previously determined rule. Furthermore, when the first touch sensor 210 is implemented to measure impedances (e.g., capacitances) varying according to whether or not the corresponding touch pads are touched, only a first touch signal corresponding to a first touch pad having the lowest impedance may indicate the touched state.

Next, in the second search mode operation, the second touch sensor 220 may determine which second touch pad is touched in touch pad groups and outputs the second touch signals tf1 to tf6 according to the determination results. The second touch sensor 220 may operate in the same way as the first touch sensor 210.

If the touch sensor unit 201 outputs the first touch signal tc2 indicating the touched state in the first search mode operation, this means that an object touches a touch pad included in the touch pad group G2 among the touch pad groups G1 to G6. And, if the touch sensor unit 201 outputs the second touch signals tf1 and tf2 indicating the touched state in the second search mode operation, this means that the object touches the first and second touch pads on the left side among touch pads included in the touch pad groups. Consequently, if the touch sensor unit 201 outputs the first touch signal tc2 indicating the touched state, and the second touch signals tf1 and tf2 indicating the touched state, this means that the object touches the touch pads P21 and P22.

The input device of FIGS. 3 to 5 having a touch panel according to the exemplary embodiment of the present invention may perform the first search mode operation and the second search mode operation simultaneously or in sequence. When the first and second search mode operations are performed in sequence, either of the first and second mode operations may be performed first.

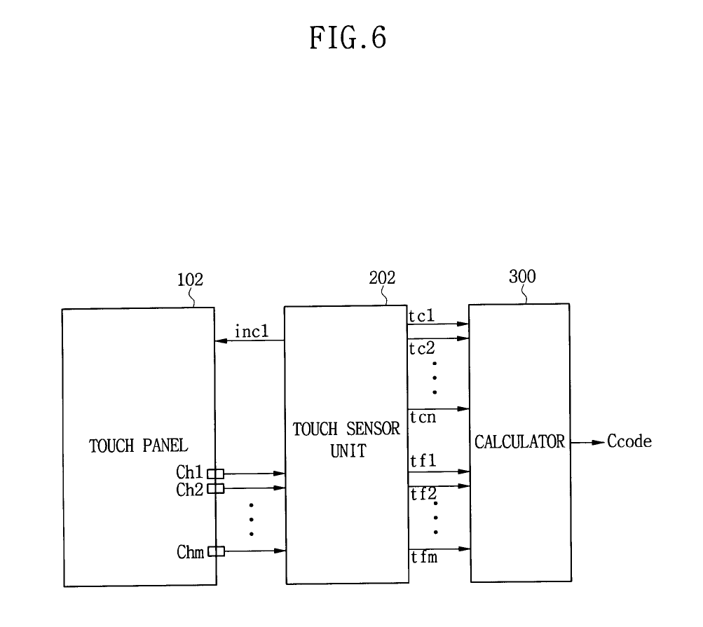

FIG. 6 is a block diagram of an input device having a touch panel according to another exemplary embodiment of the present invention. The input device may include a touch panel 102, a touch sensor unit 202 and a calculator 300.

Functions of the blocks shown in FIG. 6 will be described below.

The touch panel 102 includes a plurality of touch pads (not shown), and each touch pad may have an impedance (e.g. capacitance) varying according to whether or not an object is touched. As mentioned above, the touch pads may be formed on an ITO film. The touch pads may be connected with corresponding channels Ch1 to Chm, respectively, and the channels Ch1 to Chm may be formed in the form of a bonding pad. In addition, the touch pads are divided into a plurality of touch pad groups, and a first input signal inc1 may be applied to some of the touch pads in the touch pad groups.

The touch sensor unit 202 may be connected with the channels Ch1 to Chm. In a first search mode operation, the touch sensor unit 202 may output the first input signal inc1, determine which one of touch pads receiving the first input signal inc1 an object touches through the channels Ch1 to Chm, and output first touch signals tc1 to tcn. And, in a second search mode operation, the touch sensor unit 202 may determine which touch pad the object touches through the channels Ch1 to Chm and output second touch signals tf1 to tfm. The first touch signals tc1 to tcn indicate which one of the touch pad groups an object touches, and the second touch signals tf1 to tfm indicate at which position a touch pad touched by the object is in the touch pad groups.

The calculator 300 may function in the same way as described with reference to FIG. 3.

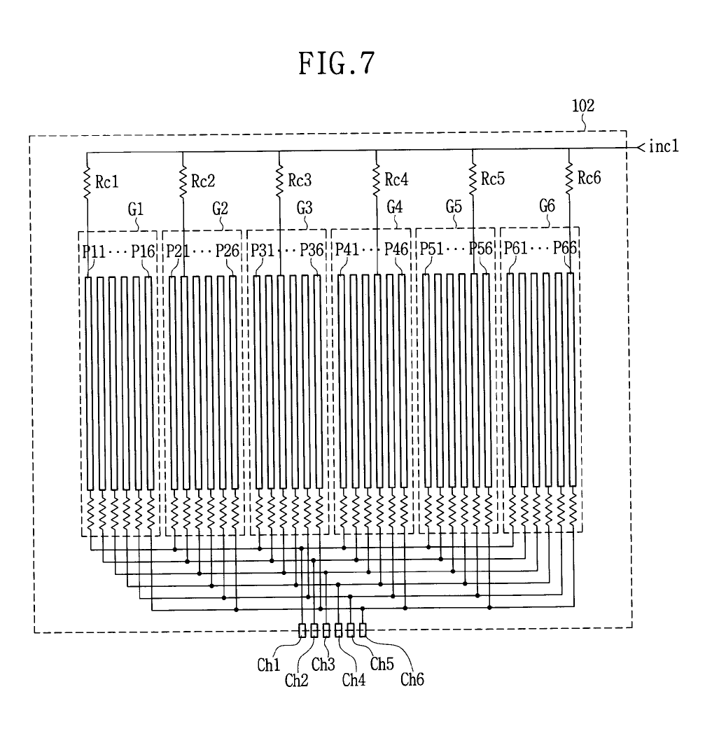

FIG. 7 illustrates an exemplary embodiment of the touch panel 102 of the input device shown in FIG. 6. The touch panel 102 may include six touch pad groups G1 to G6, and the touch pad groups G1 to G6 may each include six touch pads (P11 to P16), (P21 to P26), . . . , and (P61 to P66). Resistors below the touch pads may be formed by a coating method, and when an ITO film is used, the resistors may be formed by performing resistive coating on the edge of the ITO film.

The touch pads (P11 to P61), (P12 to P62), . . . , and (P16 to P66) may be disposed in a first direction (e.g., the direction of the x-axis) and extend in a second direction (e.g., the direction of the y-axis).

The touch pads (P11 to P61), (P12 to P62), . . . , and (P16 to P66) disposed at corresponding positions in the touch pad groups G1 to G6 are connected in common with each corresponding channel Ch1 to Ch6, and the first input signal inc1 output from the touch sensor unit 202 may be applied to one touch pad P11, P22, P33, P44, P55 and P66 in each touch pad group G1 to G6. The respective touch pads P11, P22, P33, P44, P55 and P66 receiving the first input signal inc1 are connected with different channels.

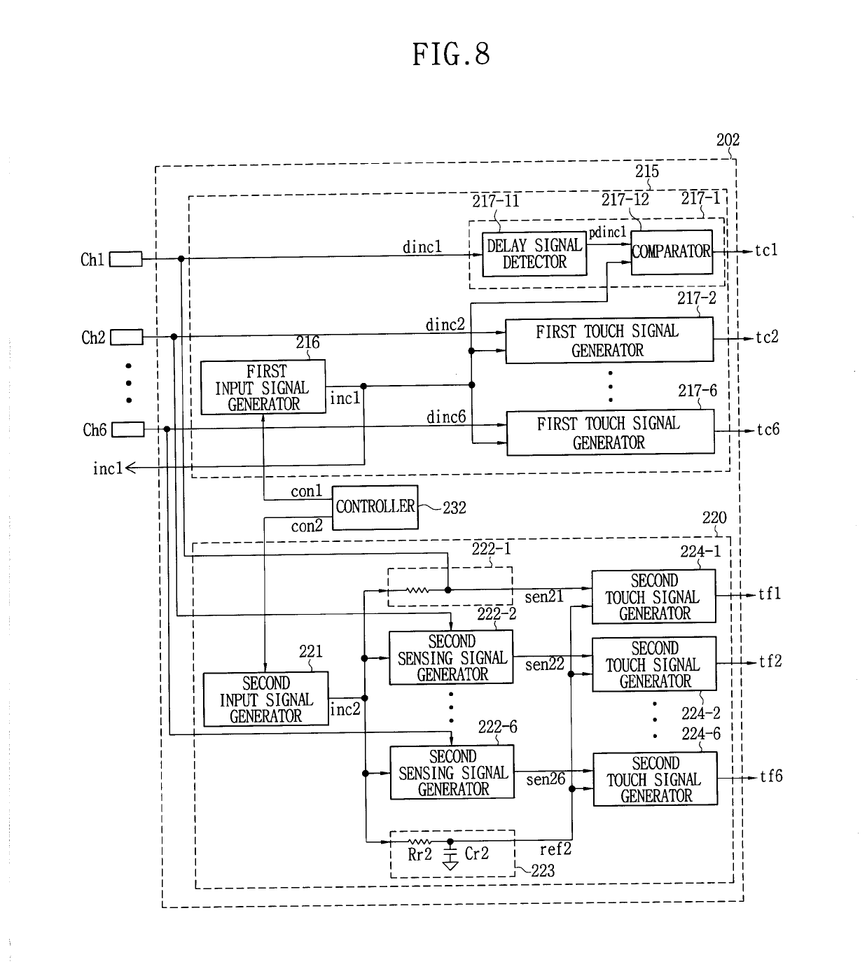

FIG. 8 illustrates an exemplary embodiment of the touch sensor unit 202 of the input device shown in FIG. 6. The touch sensor unit 202 may include a first touch sensor 215, a second touch sensor 220, and a controller 232. The first touch sensor 215 may include a first input signal generator 216 and six first touch signal generators 217-1 to 217-6, and the first touch signal generators 217-1 to 217-6 may each include a delay signal detector 217-11 and a comparator 217-12. In other words, although not shown in the drawings, the first touch signal generators 217-2 to 217-6 may be constituted the same as the first touch signal generator 217-1. The second touch sensor 220 may include a second input signal generator 221, six second sensing signal generators 221-1 to 222-6, a second reference signal generator 223 and six second touch signal generators 224-1 to 224-6. The channels Ch1 to Ch6 may be connected with the corresponding first touch signal generators 217-1 to 217-6 and the corresponding second sensing signal generators 222-1 to 222-6, respectively.

Functions of the blocks shown in FIG. 8 will be described below.

The second touch sensor 220 and the blocks in the second touch sensor 220 may function in the same way as described with reference to FIG. 5 except that the second input signal generator 221 may output a second input signal inc2 in response to a second control signal con2 output from the controller 232. In the first search mode operation, the first touch sensor 215 may detect whether or not the touch pads P11, P22, . . . , and P66 receiving the first input signal inc1 are touched and output first touch signals tc1 to tc6. The first input signal generator 216 may output the first input signal inc1. The first input signal generator 216 may output the first input signal inc1 in response to a first control signal con1 output from the controller 232. The first input signal inc1 may be a clock signal.

The six first touch signal generators 217-1 to 217-6 may be connected with the corresponding channels Ch1 to Ch6, detect delay differences between delay signals dinc1 to dinc6 input through the channels Ch1 to Ch6 and the first input signal inc1, determine whether or not the touch pads P11, P22, . . . , and P66 receiving the first input signal inc1 are touched, and output the first touch signals tc1 to tc6 each indicating whether or not the respective touch pads P11, P22, . . . , and P66 are touched, respectively. The delay signal detectors 217-11 may receive the delay signals dinc1 to dinc6 through the corresponding channels Ch1 to Ch6, detect the levels of the delay signals dinc1 to dinc6, and output pulse delay signals pdinc1 to pdinc6, respectively. The comparators 217-12 may compare delays between the corresponding pulse delay signals pdinc1 to pdinc6 and the first input signal inc1, and output the corresponding first touch signals tc1 to tc6 according to the comparison results, respectively. At this time, when delay differences are a specific time or more, the comparators 217-12 may determine that the corresponding touch pads are touched, and output the first touch signals tc1 to tc6 indicating the touched state.

Similar to the description of FIG. 5, the first touch signal generators 217-1 to 217-6 may respectively output delay differences between the corresponding delay signals dinc1 to dinc6 and the first input signal inc1, or may make only one of the first touch signals tc1 to tc6 (e.g., a first touch signal corresponding to a delay signal having the largest delay difference) indicate that the corresponding touch pad is touched.

In the first search mode operation, the controller 232 may activate the first control signal con1 to control the first input signal generator 216 to output the first input signal inc1, and in the second search mode operation, activate the second control signal con2 to control the second input signal generator 221 to output the second input signal inc2. Although not shown in the drawings, the controller 232 may control the other blocks of the first touch sensor 215 and the second touch sensor 220.

FIG. 8 shows a case in which the first touch sensor 215 is used in the first search mode operation and the second touch sensor 220 is used in the second search mode operation, but the second touch sensor 220 may be used in the first search mode operation and the first touch sensor 215 may be used in the second search mode operation.

In addition, the controller 232 may be removed from the touch sensor unit 202 of FIG. 8. In this case, the first input signal generator 216 may output the first input signal inc1 in the first search mode operation, and the second input signal generator 221 may output the second input signal inc2 in the second search mode operation.

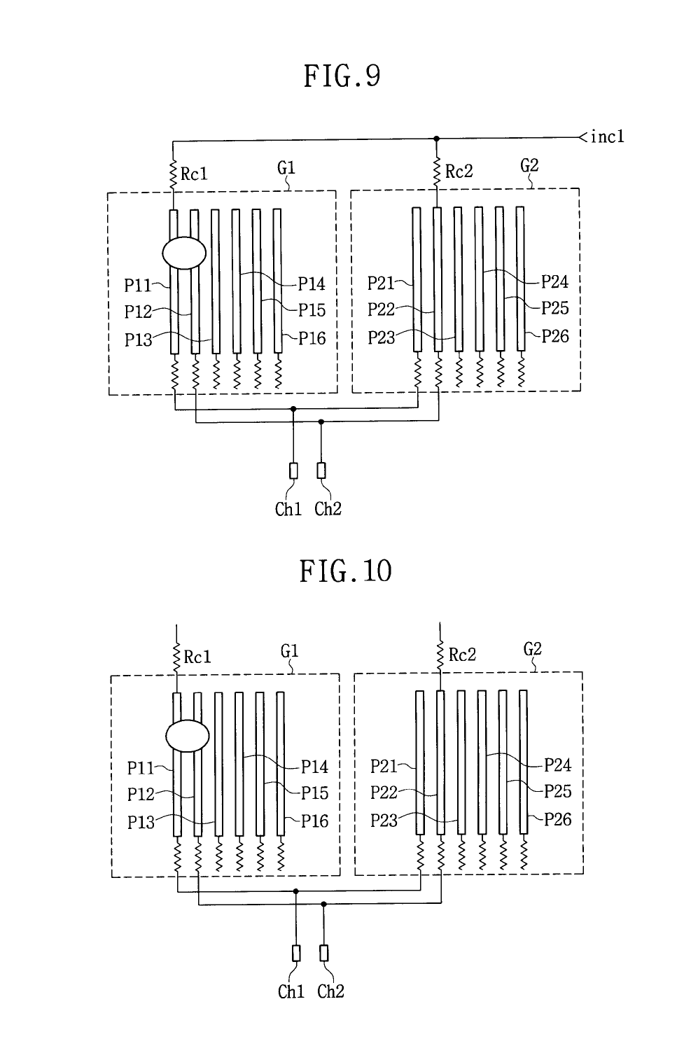

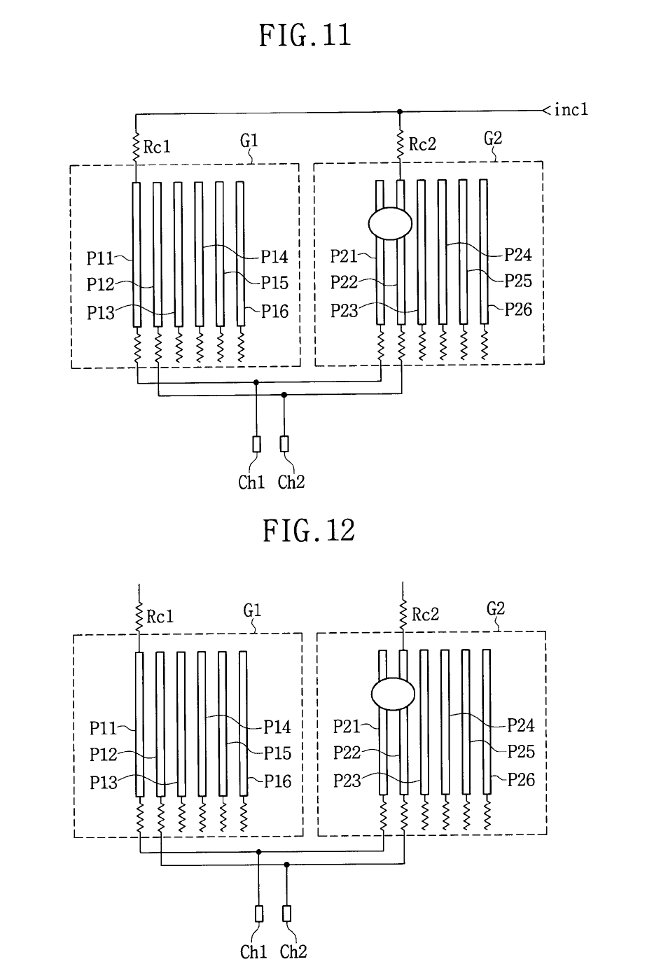

FIGS. 9 to 12 are diagrams for illustrating operation of the input device shown in FIGS. 6 to 8. FIGS. 9 to 12 show only the touch pad groups G1 and G2 of the touch panel 102. FIG. 9 illustrates the first search mode operation when an object touches the touch pads P11 and P12, FIG. 10 illustrates the second search mode operation when an object touches the touch pads P11 and P12, FIG. 11 illustrates the first search mode operation when an object touches the touch pads P21 and P22, and FIG. 12 illustrates the second search mode operation when an object touches the touch pads P21 and P22. In FIGS. 9 to 12, an ellipse denotes a part touched by an object.

Operation of the input device having a touch panel according to the exemplary embodiment of the present invention will be described below with reference to FIGS. 9 to 12.

Referring to FIG. 9, in the first search mode operation, the first touch sensor 215 of the touch sensor unit 202 may output the first input signal inc1 to the touch panel 102, receive the delay signals dinc1 to dinc6 input through the channels Ch1 to Ch6, and detect whether or not the touch pads P11, P22, . . . , and P66 receiving the first input signal inc1 are touched. Since an object is in contact with the touch pad P11 and no object is in contact with the touch pad P22, the delay signal dinc1 input to the touch sensor unit 202 through the channel Ch1 is delayed more than the delay signal dinc2 input to the touch sensor unit 202 through the channel Ch2 due to the capacitance of the object and/or the resistance of the touch pad P11. (The delays of the delay signals dinc3 to dinc6 input to the touch sensor unit 202 through the channels Ch3 to Ch6 are not so different from the delay of the delay signal dinc2.) In other words, a delay difference between the delay signal dinc1 and the first input signal inc1 is large, but a delay difference between the delay signal dinc2 and the first input signal inc1 is relatively small. Thus, in the first search mode operation, the first touch sensor 215 of the touch sensor unit 202 outputs the first touch signal tc1 indicating the touched state and the other first touch signals tc2 to tc6 indicating the non-touched state.

Referring to FIG. 10, in the second search mode operation, the second touch sensor unit 220 may determine at which position a touched touch pad is in the touch pad groups G1 to G6 and output the second touch signals tf1 to tf6. Since an object is in contact with the touch pads P11 and P12, the second touch sensor 220 may output the second touch signals tf1 and tf2 indicating the touched state and the other first touch signals tf3 to tf6 indicating the non-touched state. The operation of the second touch sensor 220 in the second mode operation will be easily understood with reference to the descriptions of FIGS. 3 to 5.

In brief, the touch sensor unit 202 may output the first touch signal tc1 indicating the touched state in the first search mode operation, and the second touch signals tf1 and tf2 indicating the touched state in the second search mode operation. In other words, it is possible to know that an object touches a touch pad included in the touch pad group G1 among the touch pad groups G1 to G6 by performing the first search mode operation, and that the object touches the first and second touch pads on the left side among touch pads included in the touch pad groups by performing the second search mode operation. Consequently, it is possible to know that the object touches the touch pads P11 and P12. As mentioned above, the input device having a touch panel according to the exemplary embodiment of the present invention may output the first and second touch signals, or may have the calculator 300 to output coordinates corresponding to the touch pads P11 and P12. When the input device has the calculator 300, the calculator 300 may receive the first and second touch signals, and calculate and output a coordinate code Ccode corresponding to the touched position, that is, the touch pads P11 and P12. In addition, as described above, the calculator 300 may increase the resolution of the input device using interpolation. More specifically, the calculator 300 may calculate the center of the touched positions, that is, a position corresponding to the touch pad P11 and a position corresponding to the touch pad P12 and output the coordinate code Ccode corresponding to the calculated center.

Referring to FIG. 11, since an object is in contact with the touch pad P22, the delay of the delay signal dinc2 output through the channel Ch2 is large, but the delays of the other delay signals dinc1 and dinc3 to dinc6 output through the other channels Ch1 and Ch3 to Ch6 are relatively small. Thus, the first touch sensor 215 outputs the first touch signal tc2 indicating the touched state and the first touch signals tc1 and tc3 to tc6 indicating the non-touched sate.

Referring to FIG. 12, as described with reference to FIG. 10, the second touch sensor 220 may output the second touch signals tf1 and tf2 indicating the touched state and the other first touch signals tf3 to tf6 indicating the non-touched state.

Since the first touch signal tc2 indicates the touched state, it is possible to know that an object touches a touch pad included in the touch pad group G2. In addition, since the second touch signals tf1 and tf2 indicate the touched state, it is possible to finally know that the object touches the touch pads P21 and P22.

Although not shown in the drawings, even if none of the touch pads P11, P22, . . . , and P66 receiving the first input signal inc1 are touched by an object, a first touch signal corresponding to a delay signal having the largest delay among the delay signals dinc1 to dinc6 may be configured to indicate the touched state as described above so that a touch position can be recognized. For example, when an object touches the touch pads P12 and P13, the delay signal dinc1 corresponding to the touch pad P11 disposed closest to the object among the touch pads P11, P22, . . . , and P66 receiving the first input signal inc1 has a large delay. In this case, the first touch sensor 215 may output the first touch signal tc1 indicating the touched state, the second touch sensor 220 may output the second touch signals tf2 and tf3 indicating the touched state, and thus it is possible to know that an object touches the touch pads P12 and P13.

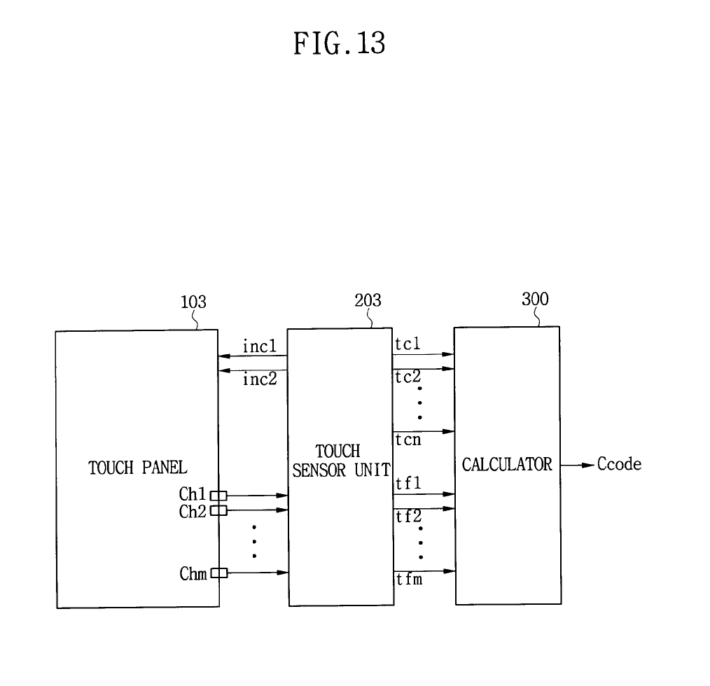

FIG. 13 is a block diagram of an input device having a touch panel according to yet another exemplary embodiment of the present invention. The input device may include a touch panel 103, a touch sensor unit 203 and a calculator 300.

Functions of the blocks shown in FIG. 13 will be described below.

The touch panel 103 includes a plurality of touch pads (not shown), and each touch pad may have an impedance (e.g. capacitance) varying according to whether or not an object is touched. As mentioned above, the touch pads may be formed on an ITO film. The touch pads may be connected with corresponding channels Ch1 to Chm, respectively, and the channels Ch1 to Chm may be formed in the form of a bonding pad. In addition, the touch pads are divided into a plurality of touch pad groups. A first input signal inc1 may be applied to some of the touch pads in the touch pad groups, and a second input signal inc2 may be applied to the other touch pads in each touch pad group.

The touch sensor unit 203 may be connected with the channels Ch1 to Chm, output the first input signal inc1 and the second input signal inc2, determine whether or not an object touches the touch pads receiving the first input signal inc1 through the channels Ch1 to Chm to output first touch signals tc1 to tcn, and determine whether or not an object touches the touch pads receiving the first input signal inc1 or the second input signal inc2 through the channels Ch1 to Chm to output second touch signals tf1 to tfm. The first touch signals tc1 to tcn indicate which one of the touch pad groups an object touches, and the second touch signals tf1 to tfm indicate at which position a touch pad touched by the object is in the touch pad groups.

The calculator 300 may function in the same way as described with reference to FIG. 3.

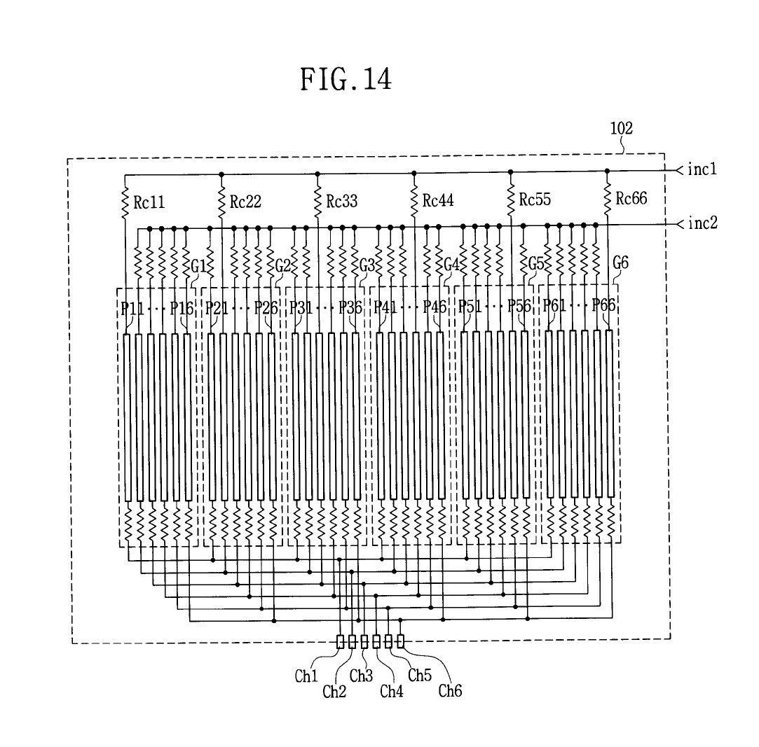

FIG. 14 illustrates an exemplary embodiment of the touch panel 103 of the input device shown in FIG. 13. The touch panel 103 may include six touch pad groups G1 to G6, and the touch pad groups G1 to G6 may each include six touch pads (P11 to P16), (P21 to P26), . . . , and (P61 to P66). As described with reference to FIG. 7, resistors below the touch pads may be formed by the coating method, and when an ITO film is used, the resistors may be formed by performing resistive coating on the edge of the ITO film.

The touch pads (P11 to P61), (P12 to P62), . . . , and (P16 to P66) may be disposed in a first direction (e.g., the direction of the x-axis) and extend in a second direction (e.g., the direction of the y-axis).

The touch pads (P11 to P61), (P12 to P62), . . . , and (P16 to P66) disposed at corresponding positions in the touch pad groups G1 to G6 are connected in common with each corresponding channel Ch1 to Ch6. The first input signal inc1 output from the touch sensor unit 203 may be applied to one touch pad P11, P22, P33, P44, P55 and P66 in each touch pad group G1 to G6, and the second input signal inc2 output from the touch sensor unit 203 may be applied to the other touch pads P12 to P16, P21, P23 to P26, P31, P32, P34 to P36, P41 to P43, P45, P46, P51 to P54, P56, and P61 to P65. The respective touch pads P11, P22, P33, P44, P55 and P66 receiving the first input signal inc1 are connected with different channels.

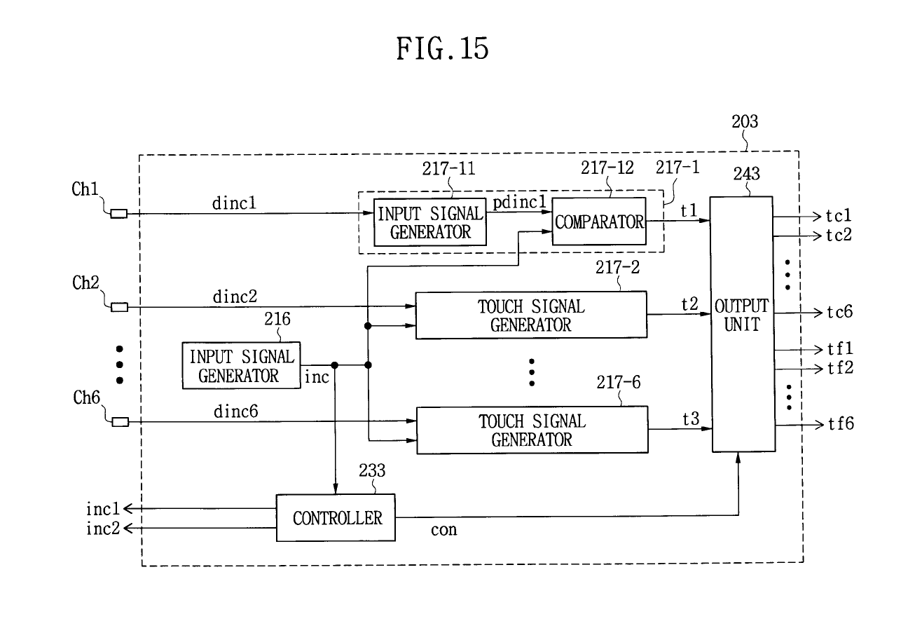

FIG. 15 illustrates an exemplary embodiment of the touch sensor unit 203 of the input device shown in FIG. 13. The touch sensor unit 203 may include an input signal generator 216, six touch signal generators 217-1 to 217-6, a controller 233 and an output unit 243, and the six touch signal generators 217-1 to 217-6 each include a delay signal detector 217-11 and a comparator 217-12. In addition, the channels Ch1 to Ch6 may be connected with the corresponding touch signal generators 217-1 to 217-6, respectively.

Functions of the blocks shown in FIG. 15 will be described below.

The input signal generator 216 may output an input signal inc. The input signal inc may be a clock signal. The six touch signal generators 217-1 to 217-6 may be respectively connected with the corresponding channels Ch1 to Ch6, and output touch signals t1 to t6 using delay differences between delay signals dine 1 to dinc6 input through the channels Ch1 to Ch6 and the input signal inc. The delay signal detectors 217-11 may receive the delay signals dinc1 to dinc6 through the corresponding channels Ch1 to Ch6, detect the levels of the delay signals dinc1 to dinc6, and output pulse delay signals pdinc1 to pdinc6, respectively. The comparators 217-12 may compare delays between the corresponding pulse delay signals pdinc1 to pdinc6 and the input signal inc, and output the corresponding touch signals t1 to t6 according to the comparison results, respectively. At this time, when delay differences are a specific time or more, the comparators 217-12 may determine that the corresponding touch pads are touched, and output the touch signals t1 to t6 indicating the touched state.

The controller 233 may receive the input signal inc output from the input signal generator 216. In a first search mode operation, the controller 233 may output the input signal inc as the first input signal inc1 and output a control signal con so that the output unit 243 outputs the touch signals t1 to t6 output from the touch signal generators 217-1 to 217-6 as first touch signals tc1 to tc6. In a second search mode operation, the controller 233 may output the input signal inc as the first input signal inc1 and the second input signal inc2 and output the control signal con so that the output unit 243 outputs the touch signals t1 to t6 output from the touch signal generators 217-1 to 217-6 as second touch signals tf1 to tf6. In the first search mode operation, the controller 233 may ground or float its terminal through which the second input signal inc2 is output.

In response to the control signal con output from the controller 233, the output unit 243 may output the touch signals t1 to t6 as the first touch signals tc1 to tc6 or as the second touch signals tf1 to tf6.

In brief, in the first search mode operation, the touch sensor unit 203 shown in FIG. 15 may output the first input signal inc1 to the touch panel 103, receive the delay signals dinc1 to dinc6 through the channels Ch1 to Ch6, and output the first touch signals tc1 to tc6 indicating in which one of the touch pad groups G1 to G6 a touch pad touched by an object touch is included. In the second search mode operation, the touch sensor unit 203 may output the first input signal inc1 and the second input signal inc2 to the touch panel 103, receive the delay signals dinc1 to dinc6 through the channels Ch1 to Ch6, and output the second touch signals tf1 to tf6 indicating at which position a touch pad touched by the object is in the touch pad groups G1 to G6.

Similar to the description of FIG. 5, the touch signal generators 217-1 to 217-6 may output delay differences between the corresponding delay signals dinc1 to dinc6 and the input signal inc, respectively. In this case, the output unit 243 may display only a first touch signal corresponding to a touch signal having the largest delay difference among the touch signals t1 to t6 to indicate the touched state. In addition, similar to the description of FIG. 5, the touch signal generators 217-1 to 217-6 may configure only one of the touch signals t1 to t6 to indicate the touched stated.

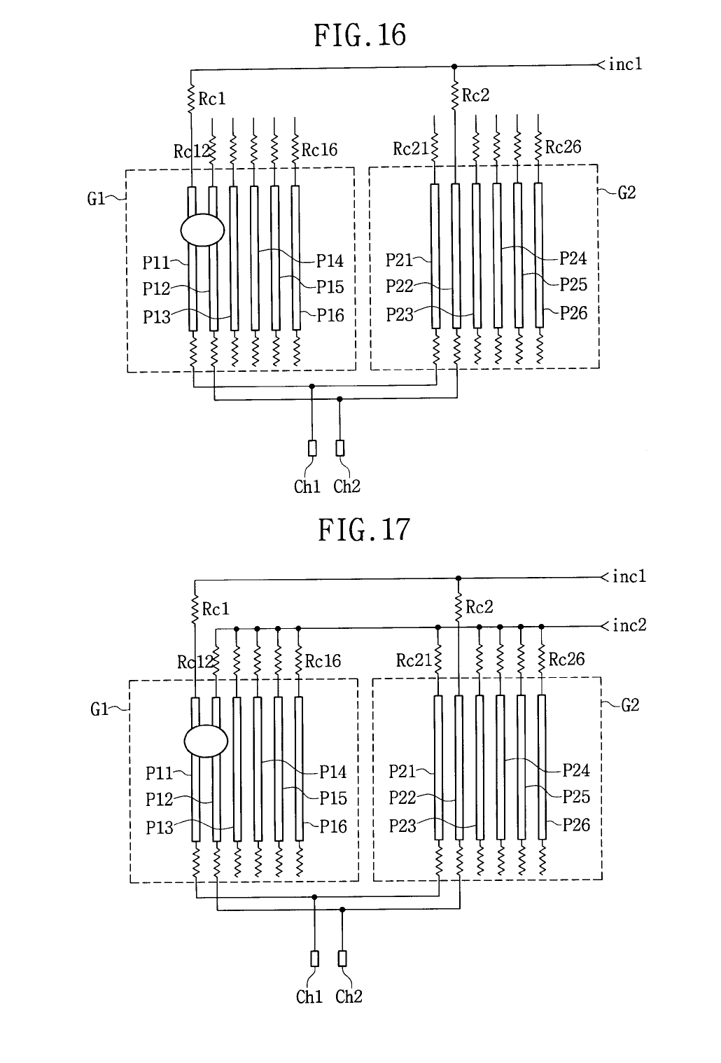

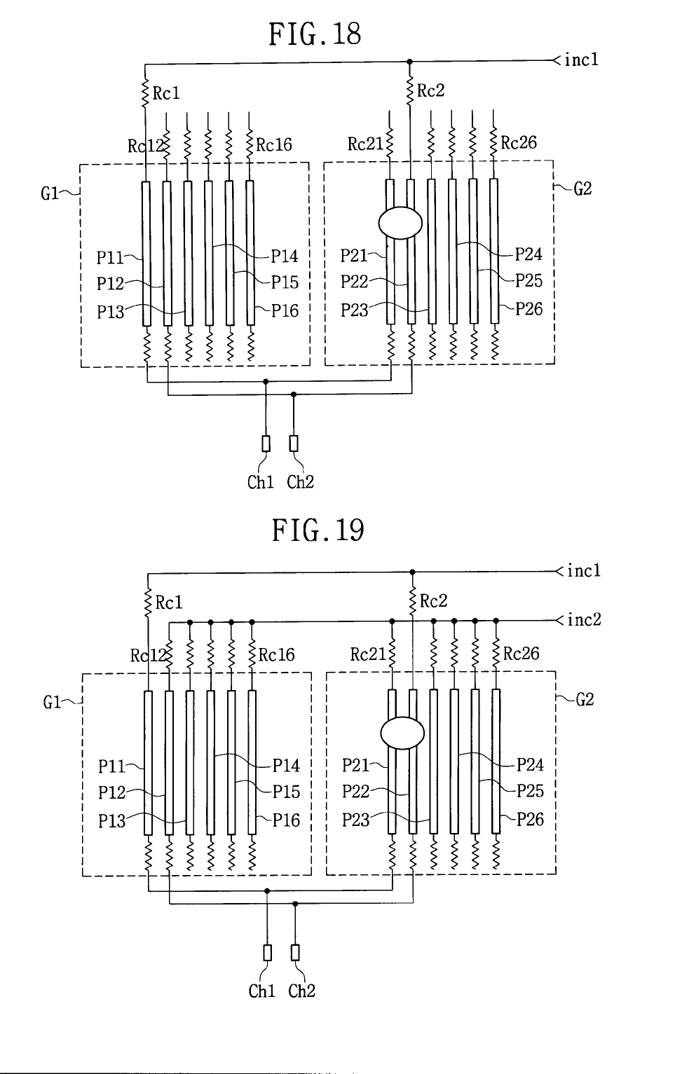

FIGS. 16 to 19 are diagrams for illustrating operation of the input device shown in FIGS. 13 to 15. FIGS. 16 to 19 show only the touch pad groups G1 and G2 of the touch panel 103. FIG. 16 illustrates the first search mode operation when an object touches the touch pads P11 and P12, FIG. 17 illustrates the second search mode operation when an object touches the touch pads P11 and P12, FIG. 18 illustrates the first search mode operation when an object touches the touch pads P21 and P22, and FIG. 19 illustrates the second search mode operation when an object touches the touch pads P21 and P22. In FIGS. 16 to 19, an ellipse denotes a part touched by an object.

Operation of the input device having a touch panel according to the exemplary embodiment of the present invention will be described below with reference to FIGS. 16 to 19.

Referring to FIG. 16, in the first search mode operation, the controller 233 of the touch sensor unit 203 may output the first input signal inc1 to the touch panel 103, and the touch signal generators 217-1 to 217-6 may receive the delay signals dinc1 to dinc6 through the channels Ch1 to Ch6 and detect whether or not the touch pads P11, P22, . . . , and P66 receiving the first input signal inc1 are touched. As described with reference to FIG. 9, since an object is in contact with the touch pad P11 and no object is in contact with the touch pad P22, a delay difference between the delay signal dinc1 and the input signal inc is large, but a delay difference between the delay signal dinc2 and the input signal inc is relatively small. Thus, the touch signal generator 217-1 of the touch sensor unit 203 outputs the touch signal t1 indicating the touched state, and the other touch signal generators 217-2 to 217-6 outputs the touch signals t2 to t6 indicating the non-touched state. The output unit 243 may output the touch signals t1 to t6 as the first touch signals tc1 to tc6. In other words, the first touch signal tc1 indicates the touched state, and the other first touch signals tc2 to tc6 indicate the non-touched state.

Referring to FIG. 17, in the second search mode operation, the touch sensor 203 determines at which position a touch pad touched by the object is in the touch pad groups G1 to G6 and outputs the second touch signals tf1 to tf6. Since an object is in contact with the touch pads P11 and P12, the touch sensor unit 203 outputs the second touch signals tf1 and tf2 indicating the touched state and the other first touch signals tf3 to tf6 indicating the non-touched state. The operation of the touch sensor unit 203 in the second mode operation will be easily understood with reference to the description of FIG. 16.

In brief, the touch sensor unit 203 may output the first touch signal tc1 indicating the touched state by performing the first search mode operation, and output the second touch signals tf1 and tf2 indicating the touched state by performing the second search mode operation. In other words, it is possible to know that an object touches a touch pad included in the touch pad group G1 among the touch pad groups G1 to G6 by performing the first search mode operation, and that the object touches the first and second touch pads on the left side among touch pads included in the touch pad groups G1 to G6 by performing the second search mode operation. Consequently, it is possible to know that the object touches the touch pads P11 and P12. As mentioned above, the input device having a touch panel according to the exemplary embodiment of the present invention may output the first touch signals tc1 to tc6 and the second touch signals tf1 to tf6, or may have the calculator 300 to output coordinates corresponding to the touch pads P11 and P12.

Referring to FIG. 18, since an object is in contact with the touch pad P22, the delay of the delay signal dinc2 output through the channel Ch2 is large, but the delays of the other delay signals dinc1 and dinc3 to dinc6 output through the other channels Ch1 and Ch3 to Ch6 are relatively small. Thus, the touch sensor unit 203 outputs the first touch signal tc2 indicating the touched state and the first touch signals tc1 and tc3 to tc6 indicating the non-touched sate.

Referring to FIG. 19, as described with reference to FIG. 17, the touch sensor unit 203 outputs the second touch signals tf1 and tf2 indicating the touched state and the other first touch signals tf3 to tf6 indicating the non-touched state in the second search mode operation.

Since the first touch signal tc2 indicates the touched state, it is possible to know that an object touches a touch pad included in the touch pad group G2. In addition, since the second touch signals tf1 and tf2 indicate the touched state, it is possible to finally know that the object touches the touch pads P21 and P22.

Although not shown in the drawings, even if none of the touch pads P11, P22, . . . , and P66 receiving the first input signal inc1 are touched by an object, a first touch signal corresponding to a delay signal having the largest delay among the delay signals dinc1 to dinc6 may be configured to indicate the touched state as described above so that a touched position can be recognized.

Thus far, a method of recognizing a touch position in the direction of the x-axis in an input device having a touch panel has been described. However, bar-shaped touch pads may be disposed perpendicular to each other, and an exemplary embodiment of the present invention may be applied in the directions of the x-axis and the y-axis to recognize coordinates of a touch position in a plane. In this case, touch pads disposed in the vertical direction and touch pads disposed in the horizontal direction may be formed on different surfaces of an ITO film, or on the same surface with crossing parts insulated from each other.

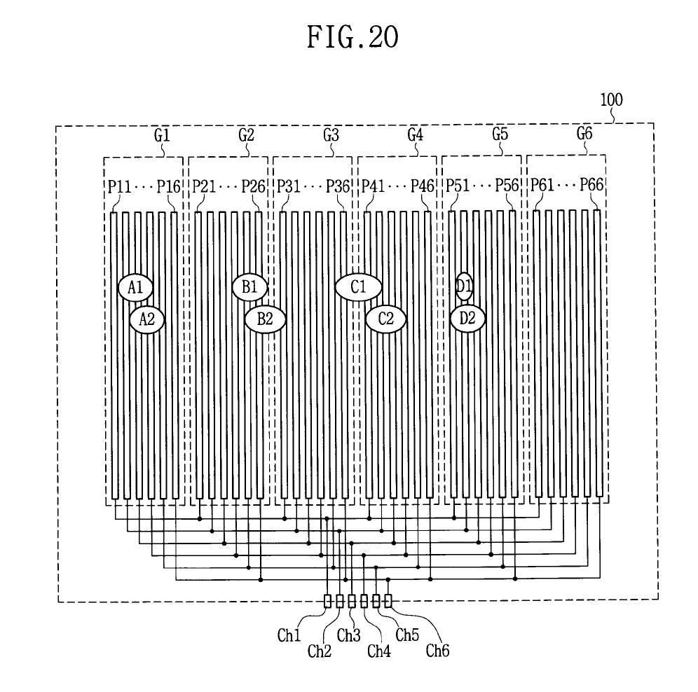

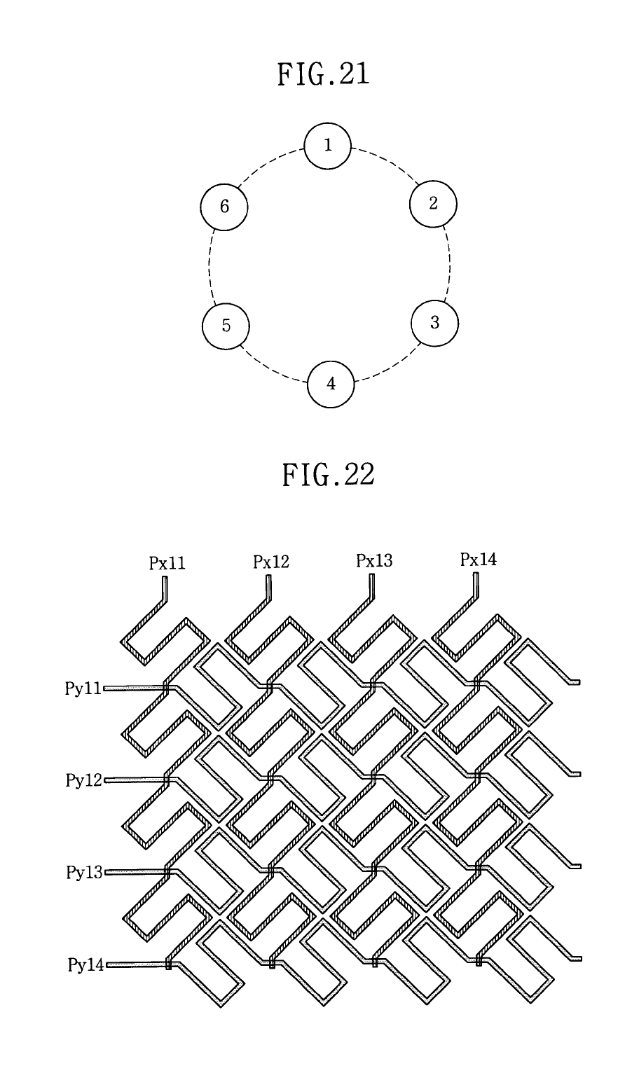

FIG. 20 is a diagram for illustrating a method for a calculator 300 of an input device having a touch panel according to an exemplary embodiment of the present invention to perform a scroll operation, in which ellipses denote parts touched by an object. In addition, FIG. 21 is a diagram for illustrating the concept of the method for the calculator 300 of an input device having a touch panel according to an exemplary embodiment of the present invention to perform a scroll operation.

The method for the calculator 300 to perform a scroll operation will be described below with reference to FIGS. 20 and 21.

The calculator 300 may calculate the coordinates of a touch position of an object using the above-described method and perform the scroll operation, or may perform the scroll operation using only second touch signals tf1 to tfm output in a second search mode operation. The latter method will be described below.

Referring to FIGS. 20 and 21, 1 is defined as a case in which touch pads P11, P21, . . . , and P61 are touched, 2 is defined as a case in which touch pads P12, P22, . . . , and P62 are touched, 3 is defined as a case in which touch pads P13, P23, . . . , and P63 are touched, 4 is defined as a case in which touch pads P14, P24, . . . , and P64 are touched, 5 is defined as a case in which touch pads P15, P25, . . . , and P65 are touched, and 6 is defined as a case in which touch pads P16, P26, . . . , and P66 are touched. When a touch case varies in a clockwise direction, a scroll direction is from left to right, and when a touch case varies in a counterclockwise direction, a scroll direction is from right to left.

Examples will be described with reference to FIG. 20. In the case of A1, an object is in contact with the touch pads P12, P13 and P14, and thus a touch sensor unit may output second touch signals tf2, tf3 and tf4 indicating the touched state in the second search mode operation. In the case of A2, an object is in contact with the touch pads P13, P14 and P15, and thus the touch sensor unit may output second touch signals tf3, tf4 and tf5 indicating the touched state in the second search mode operation. When an object moves from A1 to A2, touch cases are changed from 2, 3 and 4 to 3, 4 and 5 in the clockwise direction, and it is possible to know that a scroll direction is from left to right.

In the case of B1, an object is in contact with the touch pads P24, P25 and P26, and thus the touch sensor unit may output second touch signals tf4, tf5 and tf6 indicating the touched state in the second search mode operation. In the case of B2, the touch sensor unit may likewise output the second touch signals tf5, tf6 and tf1 indicating the touched state. When an object moves from B1 to B2, touch cases are changed from 4, 5 and 6 to 5, 6 and 1 in the clockwise direction, and it is possible to know that a scroll direction is from left to right.

In the case of C1, the second touch signals tf6, tf1 and tf2 indicating the touched state are output, and in the case of C2, the second touch signals tf1, tf2, tf3 and tf4 indicating the touched state are output. When an object moves from C1 to C2, touch cases are changed from 6, 1 and 2 to 1, 2, 3 and 4 in the clockwise direction, and it is possible to know that a scroll direction is from left to right.

In the case of D1, the second touch signal tf2 indicating the touched state is output, and in the case of D2, the second touch signals tf1, tf2 and tf3 indicating the touched state are output. When an object moves from D1 to D2, touch cases are changed from 2 to 1, 2 and 3, and thus the movement may be determined to be invalid.

When the input device of FIGS. 6 to 8 having a touch panel according to the exemplary embodiment of the present invention is configured to perform only a scroll operation as described with reference to FIGS. 20 and 21, the first input signal inc1 may not need to be input to the touch pads P11, P22, . . . , and P66 of the touch panel 102, and the touch sensor unit 202 may include only the second touch sensor 220. In addition, when the input device of FIGS. 13 to 15 having a touch panel according to the exemplary embodiment of the present invention is configured to perform only a scroll operation as described with reference to FIGS. 20 and 21, the same input signal may be input to all the touch pads (P11, P12, . . . , P16), (P21, P22, . . . , P26), . . . , and (P61, P62, . . . , P66) instead of the classified first and second input signals inc1 and inc2.

For convenience, FIGS. 1, 2, 4, 7, 9 to 12, 14, and 16 to 20 show touch pads formed in a bar shape, but the touch pads may have various shapes. For example, both ends of each touch pad may have different areas to be touched by an object, that is, an area to be touched by an object may increase from one end to the other end in odd-numbered touch pads and decrease from one end to the other end in even-numbered touch pads.

In addition, the drawings show touch panels capable of detecting a touch position in the first direction (e.g., the direction of the x-axis), but a touch panel according to an exemplary embodiment of the present invention may additionally have a layer in which touch pads for detecting a touch position in the second direction (e.g., the direction of the y-axis) are formed in order to detect a touch position in the second direction (e.g., the direction of the y-axis) in the y-axis as well as the first direction (e.g., the direction of the x-axis). In other words, a touch panel according to an exemplary embodiment of the present invention may additionally have a layer in which touch pads are formed as shown in FIG. 4, 7 or 14. In this case, the touch pads formed in the additional layer may be disposed in a different direction from the touch pads of an existing layer for detecting a touch position in the x-axis (e.g., disposed perpendicular to the touch pads of the existing layer) and can be used to detect a touch position in the y-axis.

When the touch panel additionally has the layer for detecting a touch position in the y-axis, a touch sensor unit may sequentially detect whether or not the touch pads formed in the existing layer are touched and whether or not the touch pads formed in the additional layer are touched, or may have additional touch sensor circuits for detecting whether or not the touch pads formed in the additional layer are touched.

In addition, a touch panel according to an exemplary embodiment of the present invention may be configured to detect a touch position in the y-axis as well as the x-axis using one layer.

Furthermore, when a touch panel and a touch sensor unit are configured to detect a touch position in the x-axis and the y-axis, the calculator 300 of an input device having a touch panel according to an exemplary embodiment of the present invention may receive touch signals output from the touch sensor unit and output a coordinate code corresponding to the coordinates of a touch position in a plane.

FIGS. 22 to 24 show exemplary embodiments of a touch panel of an input device of the present invention. FIGS. 22 to 24 show touch panels additionally having a layer in which touch pads for detecting a touch position in the y-axis are formed. In FIGS. 22 to 24, shaded lines denote touch pads for obtaining an x-coordinate, and dotted lines denote touch pads for obtaining a y-coordinate.

The touch panel of an input device according to an exemplary embodiment of the present invention may use bar-shaped touch pads as shown in FIGS. 4, 7 and 14, but may have patterns as shown in FIGS. 22 to 24 in order to increase an area of each touch pad to be touched. More specifically, touch pads Px11, Px12, . . . , which are disposed in the direction of the x-axis and extend in the direction of the y-axis to obtain an x-coordinate, may be formed in a specific area having a first length in the direction of the x-axis and a second length in the direction of the y-axis, and may be formed in a specific pattern (e.g., slant zigzag patterns as shown in FIGS. 22 to 24) so that the length of each touch pad Px11, Px12, . . . is longer than the second length. In addition, touch pads Py11, Py12, . . . , which are disposed in the direction of the y-axis and extend in the direction of the x-axis to obtain a y-coordinate, may be formed in a specific area having a third length in the direction of the y-axis and a fourth length in the direction of the x-axis, and may be formed in the specific pattern so that the length of each touch pad Py11, Py12, . . . is longer than the fourth length.

In the touch panels shown in FIGS. 22 to 24, the specific pattern of each touch pad Px11, Px12, . . . may be repeatedly formed in the direction of the y-axis, and the specific pattern of each touch pad Py11, Py12, . . . may be repeatedly formed in the direction of the x-axis. In addition, the touch pads Px11, Px12, . . . may be disposed in the direction of the x-axis so that the specific patterns are disposed in the same y-axis, and the touch pads Py11, Py12, . . . may be disposed in the direction of the y-axis so that the specific patterns are disposed in the same x-axis.

In the touch panel shown in FIG. 22, the touch pads Px11, Px12, . . . , Py11, Py12, . . . may be disposed so that the specific patterns of the touch pads Px11, Px12, . . . do not overlap the specific patterns of the touch pads Py11, Py12, . . . , that is, each specific pattern of the touch pads Px11, Px12, . . . may be disposed in each empty space between the specific patterns of the touch pads Py11, Py12, . . . . Here, junctions between the specific patterns of the touch pads Px11, Px12, . . . cross junctions between the specific patterns of the touch pads Py11, Py12, . . . .

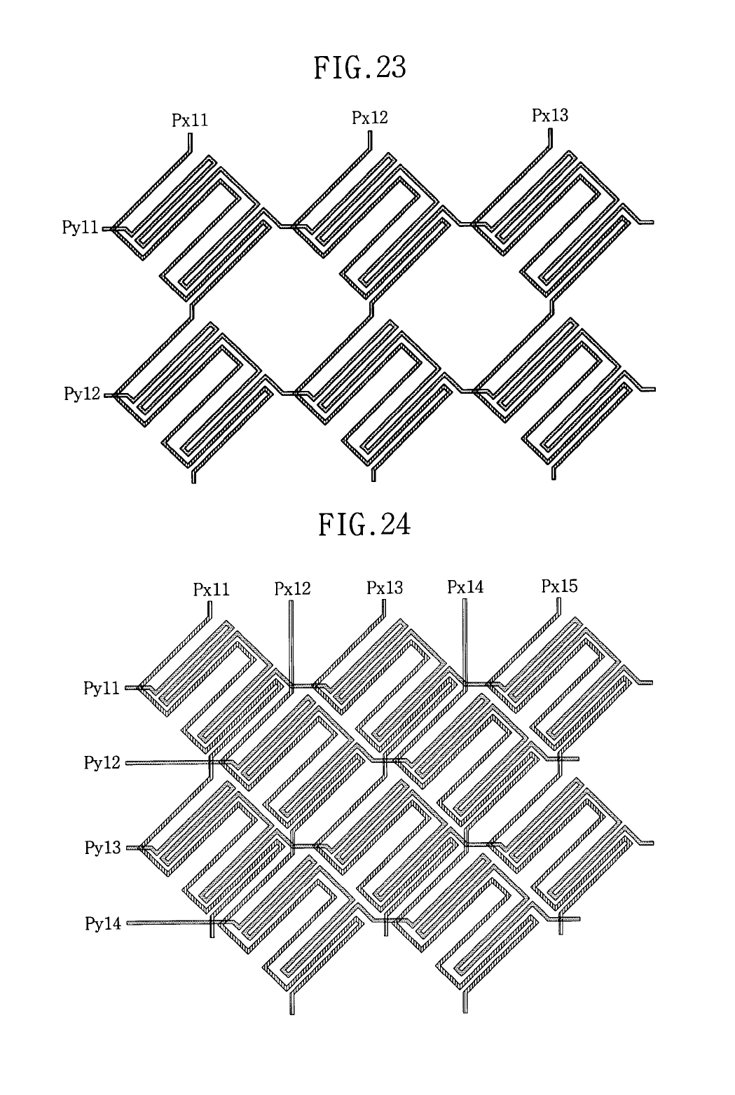

In the touch panel shown in FIG. 23, the touch pads Px11, Px12, . . . , Py11, Py12, . . . may be disposed so that their specific patterns are entangled. Here, junctions between the specific patterns of the touch pads Py11, Py12, . . . cross the specific patterns of the touch pads Px11, Px12, . . . , respectively.

In the touch panel shown in FIG. 24, the touch pads Px11, Px12, . . . , Py11, Py12, . . . may be disposed so that the specific patterns are entangled. Here, junctions between the specific patterns of the touch pads Py11, Py12, . . . respectively cross the specific patterns of the touch pads Px11, Px12, . . . , and junctions between the specific patterns of the touch pads Px11, Px12, . . . respectively cross the specific patterns of the touch pads Py11, Py12, . . . .

In the touch panels shown in FIGS. 22 to 24, the touch pads Px11, Px12, . . . and the touch pads Py11, Py12, . . . may be formed using the both surfaces of one ITO film. More specifically, the touch pads Px11, Px12, . . . may be formed on the upper surface of the ITO film, and the touch pads Py11, Py12, . . . may be formed on the lower surface of the ITO film. In addition, the touch pads Px11, Px12, . . . and the touch pads Py11, Py12, . . . all may be formed on one surface of the ITO film. In this case, intersections of the touch pads Px11, Px12, . . . and the touch pads Py11, Py12, . . . must be insulated.

A touch panel and a touch panel of an input device according to exemplary embodiments of the present invention may be implemented in various modified forms other than those shown in FIGS. 22 to 24.

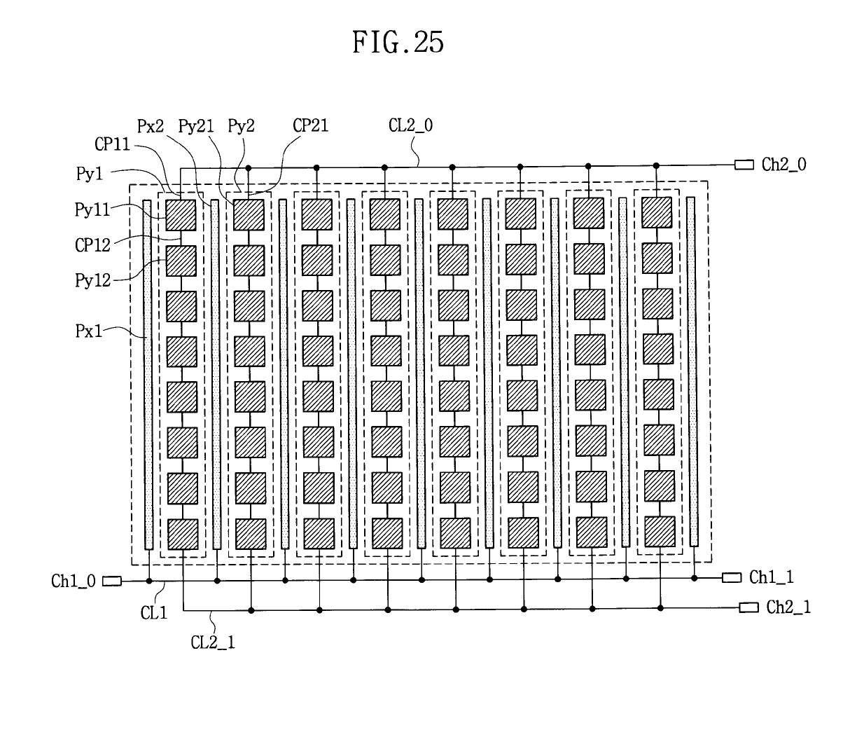

FIGS. 25, 27 and 28 illustrate other exemplary embodiments of a touch panel of an input device according to an exemplary embodiment of the present invention. The exemplary embodiments of a touch panel can recognize a touch position in the y-axis as well as the x-axis using one conductive layer.

FIG. 25 illustrates a first form of a touch panel according to another exemplary embodiment of the present invention. The touch panel may include a plurality of first electrodes Px1, Px2, . . . disposed in a first direction (e.g., the direction of the x-axis) and a plurality of second electrodes Py1, Py2, . . . each disposed between the first electrodes Px1, Px2, . . . in the first direction. The second electrodes Py1, Py2, . . . may each include a plurality of touch pads (Py11, Py12, . . . ), (Py21, Py22, . . . ), . . . disposed in a second direction (e.g., the direction of the y-axis) perpendicular to the first direction and connection pads (CP11, CP12, . . . ), (CP21, CP22, . . . ), . . . connecting the touch pads. In addition, one end of each first electrode Px1, Px2, . . . may be connected with a first connection line CL1 connecting a first transmission channel Ch1_0 with a first reception channel Ch1_1, one end of each second electrode Py1, Py2, . . . may be connected with a second transmission channel Ch2_0 through a second transmitting connection line CL2_0, and the other end of each second electrode Py1, Py2, . . . may be connected with a second reception channel Ch2_1 through a second receiving connection line CL2_1. The first electrodes Px1, Px2, . . . may be formed to have low resistance, and the first connection line CL1 may be formed to have high resistance. For example, the first connection line CL1 may be formed of a material having a different feature from that of the first electrodes Px1, Px2, . . . . Otherwise, the first connection line CL1 may be formed of a material having the same feature as that of the first electrodes Px1, Px2, . . . to have a decreasing width or in a zigzag shape to have an extended length. The second transmitting connection line CL2_0 and the second receiving connection line CL2_1 may be formed of metal or a material having low resistance similar to metal, that is, a material having high conductivity. In addition, the first electrodes Px1, Px2, . . . and the second electrodes Py1, Py2, . . . may be formed using an ITO film. In this case, the first electrodes Px1, Px2, . . . and the second electrodes Py1, Py2, . . . may be formed on one ITO film, or may be formed on different ITO films, respectively. When the touch panel shown in FIG. 25 is formed on a liquid crystal display (LCD) or organic light-emitting device (OLED), the second electrodes Py1, Py2, . . . may be formed on an ITO film of the LCD or OLED, and the first electrodes Px1, Px2, . . . may be formed using the black matrix of the LCD or OLED.

In addition, the touch pads (Py11, Py12, . . . ), (Py21, Py22, . . . ), . . . constituting the second electrodes Py1, Py2, . . . may be made large to be easily touched by an object, and thus have lower resistance than the connection pads (CP11, CP12, . . . ), (CP21, CP22, . . . ), . . . .

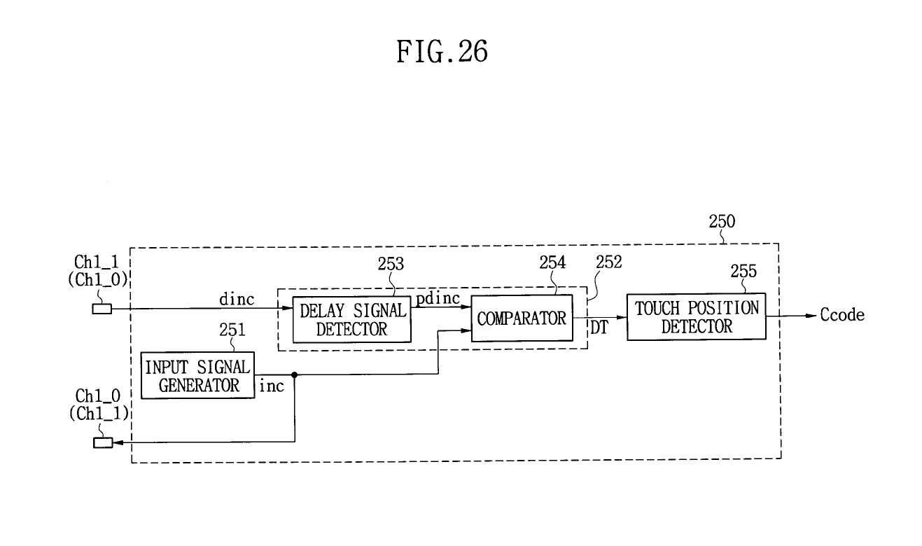

FIG. 26 is a block diagram of a touch sensor 250 using the exemplary embodiment of a touch panel shown in FIG. 25. The touch sensor 250 may include an input signal generator 251, a delay detector 252 and a touch position detector 255, and the delay detector 252 includes a delay signal detector 253 and a comparator 254.

Functions of the blocks shown in FIG. 26 will be described below.

The input signal generator 251 may output an input signal inc. The input signal inc may be a clock signal. The input signal inc may be simultaneously output to the touch panel through the first transmission channel Ch1_0 and to the comparator 254.

The delay detector 252 may detect a delay difference DT between a delay signal dinc input through the first reception channel Ch1_1 and the input signal inc and output the detected delay difference DT. The delay signal detector 253 may receive the delay signal dinc, detect the level of the delay signal dinc, and output a pulse delay signal pdinc. The comparator 254 may receive the pulse delay signal pdinc and the input signal inc and output the delay DT of the pulse delay signal pdinc relative to the input signal inc.

The touch position detector 255 may receive the delay DT and output coordinate code Ccode corresponding to the delay DT.

A touch sensor connected with the second transmission channel Ch2_0 and the second reception channel Ch2_1 may also have the same constitution as the touch sensor 250 shown in FIG. 26. In other words, an input device having the exemplary embodiment of a touch panel of the present invention may include the touch panel shown in FIG. 25, a first touch sensor unit connected with the first transmission channel Ch1_0 and the first reception channel Ch1_1, and a second touch sensor unit connected with the second transmission channel Ch2_0 and the second reception channel Ch2_1, and the first touch sensor unit and the second touch sensor unit may have the touch sensor shown in FIG. 26.

Operation of an input device having the exemplary embodiment of a touch panel of the present invention will be described below with reference to FIGS. 25 and 26.

In the first search mode operation, the touch sensor 250 may output an input signal inc through the first transmission channel Ch1_0 and receive a delay signal dinc through the first reception channel Ch1_1. The delay of the delay signal dinc is determined by the resistance of the first connection line CL1 to a first electrode touched by an object and the capacitance of the object. Thus, by detecting the delay, it is possible to know which one of the first electrodes Px1, Px2, . . . the object touches. Consequently, the touch sensor 250 can obtain a touch position in the x-axis by detecting a delay difference between an input signal and a delay signal. In addition, the touch sensor 250 may output an input signal through the first transmission channel Ch1_0, receive a delay signal through the first reception channel Ch1_1, detect a first delay difference between the input signal and the delay signal, additionally output the input signal through the first reception channel Ch1_1, additionally receive a delay signal through the first transmission channel Ch1_0, detect a second delay difference between the additional input signal and the additional delay signal, calculate touch positions corresponding to the first and second delay differences in the x-axis, and obtain a touch position in the x-axis using the average of the two touch positions.

In the second search mode operation, the touch sensor 250 may output an input signal through the second transmission channel Ch2_0, receive a delay signal through the second reception channel Ch2_1, detect a delay difference between the input signal and the delay signal, and obtain a touch position in the y-axis. In other words, the delay of the delay signal input through the second reception channel Ch2_1 varies according to the resistance of a second electrode to the position touched by the object. Thus, the touch sensor 250 can obtain the touch position in the y-axis by detecting a delay difference between the delay signal input through the second reception channel Ch2_1 and the input signal. In addition, as described in the first search mode operation, the touch sensor 250 may output an input signal through the second transmission channel Ch2_0, receive a delay signal through the second reception channel Ch2_1, detect a first delay difference between the input signal and the delay signal, additionally output the input signal through the second reception channel Ch2_1, additionally receive a delay signal through the second transmission channel Ch2_0, detect a second delay difference between the additional input signal and the additional delay signal, and obtain a touch position in the y-axis using the first and second delay differences.

In brief, an input device having the touch panel shown in FIG. 25 according to an exemplary embodiment of the present invention can detect a touch position in the x-axis by performing the first search mode operation and detect a touch position in the y-axis by performing the second search mode operation, thereby obtaining the coordinates of a touch position in a plane. The first and second search mode operations may be performed simultaneously or in sequence. When the first and second search mode operations are performed in sequence, either of the first and second mode operations may be performed first.

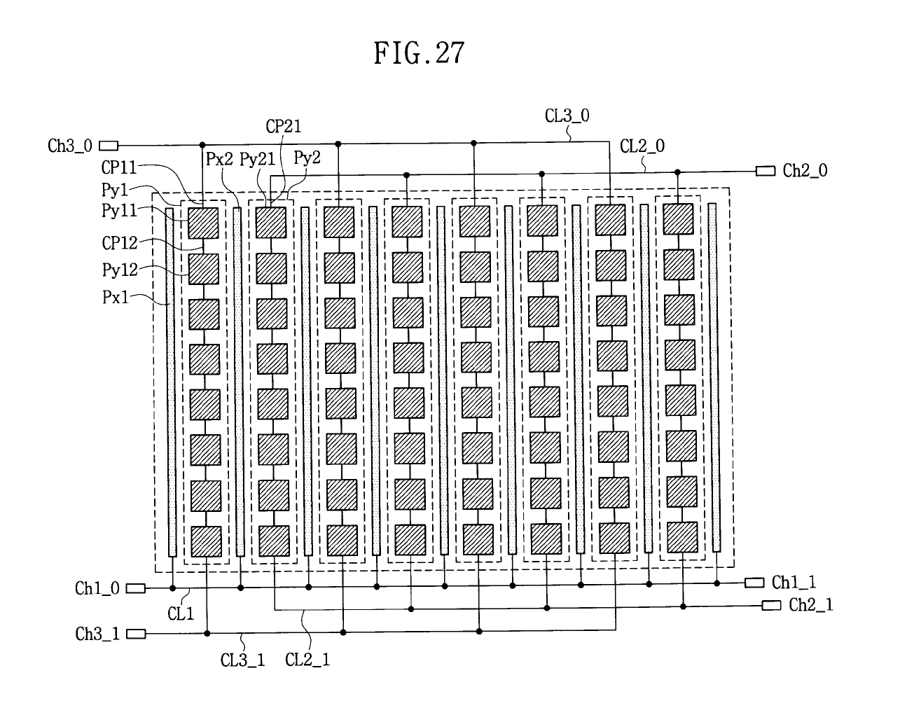

FIG. 27 illustrates a second form of a touch panel according to another exemplary embodiment of the present invention. The touch panel may have the same constitution as shown in FIG. 25 except that the second electrodes Py1, Py2, . . . are alternately connected with a pair of the second transmission channel Ch2_0 and the second reception channel Ch2_1 and a pair of a third transmission channel Ch3_0 and a third reception channel Ch3_1. More specifically, one end of each odd-numbered second electrode Py1, Py3, . . . among the second electrodes Py1, Py2, . . . is connected with the second transmission channel Ch2_0 through the second transmitting connection line CL2_0, and the other end is connected with the second reception channel Ch2_1 through the second receiving connection line CL2_1. And, one end of each even-numbered second electrode Py2, Py4, . . . is connected with the third transmission channel Ch3_0 through a third transmitting connection line CL3_0, and the other end is connected with the third reception channel Ch3_1 through a third receiving connection line CL3_1. The second transmitting connection line CL2_0, the second receiving connection line CL2_1, the third transmitting connection line CL3_0 and the third receiving connection line CL3_1 may be formed of metal or a material having low resistance similar to metal, that is, a material having high conductivity.

In addition, the touch sensor shown in FIG. 26 may also be used in an input device employing the touch panel shown in FIG. 27. In other words, when an input device has the second form of a touch panel according to the exemplary embodiment of the present invention, it may include the touch panel shown in FIG. 27, a first touch sensor unit connected with the first transmission channel Ch1_0 and the first reception channel Ch1_1, a second odd touch sensor unit connected with the second transmission channel Ch2_0 and the second reception channel Ch2_1, and a second even touch sensor unit connected with the third transmission channel Ch3_0 and the third reception channel Ch3_1. Here, the first touch sensor unit, the second odd touch sensor unit, and the second even touch sensor unit may include the touch sensor shown in FIG. 26. In this case, the input device according to an exemplary embodiment of the present invention may additionally include an output unit which outputs as coordinates of a touch position the middle value of second odd coordinate output from the second odd touch sensor unit and second even coordinate output from the second even touch sensor unit.

In addition, an input device according to an exemplary embodiment of the present invention may include only one second touch sensor unit instead of the second odd touch sensor unit and the second even touch sensor unit. In this case, the second touch sensor unit may be first connected with the second transmission channel Ch2_0 and the second reception channel Ch2_1 to detect a touch position, and then connected with the third transmission channel Ch3_0 and the third reception channel Ch3_1 to detect a touch position. Furthermore, similar to the foregoing description, the second touch sensor unit may output a coordinate corresponding to the middle of the touch position detected through the second transmission channel Ch2_0 and the second reception channel Ch2_1 and the touch position detected through the third transmission channel Ch3_0 and the third reception channel Ch3_1.

Operation of an input device having the second form of a touch panel of FIG. 27 according to the exemplary embodiment of the present invention will be described below.

The first search mode operation is the same as described with reference to FIGS. 25 and 26.

The second search mode operation is also the same as described with reference to FIGS. 25 and 26 except that a touch sensor unit applies an input signal to a touch pad unit through the second transmission channel Ch2_0 and the third transmission channel Ch3_0 and receives a delay signal through the second reception channel Ch2_1 and the third reception channel Ch3_1.

In other words, even if a large object touches two touch pads (e.g., Py11 and Py21) formed in two second electrodes (e.g., Py1 and Py2), the touch panel shown in FIG. 27 can stably operate and also improve its resolution. In addition, as mentioned with reference to FIG. 25, an input device having the second form of a touch panel according to the exemplary embodiment of the present invention can perform the first search mode operation and the second search mode operation simultaneously or in sequence.

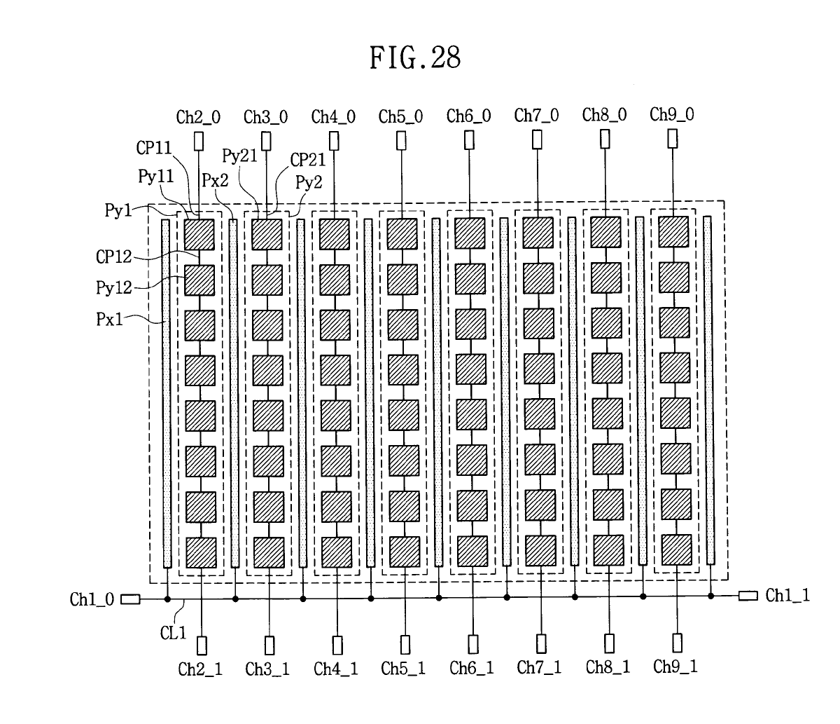

FIG. 28 illustrates a third form of a touch panel according to another exemplary embodiment of the present invention. The touch panel may have the same constitution as shown in FIG. 25 except that the second electrodes Py1, Py2, . . . each are connected with the corresponding channels among a plurality of pairs of transmission and reception channels (Ch2_0 and Ch2_1), (Ch3_0 and Ch3_1), . . . . More specifically, one end of each second electrode Py1, Py2, . . . may be connected with the corresponding one of the transmission channels Ch2_0, Ch3_0, . . . , and the other end may be connected with the corresponding one of the reception channels Ch2_1, Ch3_1, . . . .

In addition, similar to the foregoing description, the touch sensor 250 shown in FIG. 26 may also be used in an input device having the third form of a touch panel of FIG. 28 according to the exemplary embodiment of the present invention. In this case, the input device according to an exemplary embodiment of the present invention may have a plurality of touch sensors each connected with the pairs of transmission and reception channels (Ch2_0 and Ch2_1), (Ch3_0 and Ch3_1), . . . , or one touch sensor selectively connected with one of the pairs of transmission and reception channels (Ch2_0 and Ch2_1), (Ch3_0 and Ch3_1) . . . .

Operation of an input device having the third form of a touch panel of FIG. 28 according to the exemplary embodiment of the present invention will be described below.

The first search mode operation is the same as described with reference to FIGS. 25 and 26.

The second search mode operation may be performed on some of the pairs of transmission and reception channels (Ch2_0 and Ch2_1), (Ch3_0 and Ch3_1), . . . selected according to the result of the first search mode operation. For example, when it is determined in the first search mode operation that an object touches a first electrode Px2, a touch sensor unit may select a pair of channels Ch3_0 and Ch3_1 (or pairs of channels (Ch2_0 and Ch2_1) and (Ch3_0 and Ch3_1)) corresponding to the first electrode Px2, output an input signal and receive a delay signal through only the selected pair of channels and detect a touch position in the y-axis.

In an input device having the third form of a touch panel of FIG. 28 according to the exemplary embodiment of the present invention, the touch sensor unit may apply an input signal to some of the second electrodes through a selected channel and receive only a delay signal delayed by the some of the second electrodes to detect a touch position, so that power consumption can be reduced. In addition, even if a touching object is large or several electrodes (or touch pads) are touched at a time, a touched position can be accurately detected.

When the exemplary embodiments of a touch panel shown in FIGS. 25, 27 and 28 are used, separate touch sensors may be prepared for respective channels, or a plurality of channels may be connected with one touch sensor. In addition, each touch sensor may have the constitution shown in FIG. 26.

Thus, an input device having a touch panel according to an exemplary embodiment of the present invention can detect a position touched by an object using a small number of channels and a small number of touch sensors.

While the invention has been shown and described with reference to certain exemplary embodiments thereof, it will be understood by those skilled in the art that various changes in form and details may be made therein without departing from the spirit and scope of the invention as defined by the appended claims.

1. A touch panel, comprising:
a plurality of first touch pad groups disposed in a first direction and having a plurality of first touch pads disposed in the first direction and extending in a second direction,
wherein the first touch pads disposed at the same position in the respective first touch pad groups are connected in common with a corresponding one of a plurality of first channels, a first input signal is applied to one of the first touch pads of each first touch pad group, and the first touch pads receiving the first input signal are respectively connected with the first channels.

2. The touch panel of claim 1, further comprising:
a plurality of second touch pad groups disposed in the second direction and having a plurality of second touch pads disposed in the second direction and extending in the first direction,
wherein the second touch pads disposed at the same position in the respective second touch pad groups are connected in common with a corresponding one of a plurality of second channels, a second input signal is applied to one of the second touch pads of each second touch pad group, and the second touch pads receiving the second input signal are respectively connected with the second channels.

3. The touch panel of claim 1, wherein a second input signal is applied to the first touch pads not receiving the first input signal.

4. The touch panel of claim 3, further comprising:
a plurality of second touch pad groups disposed in the second direction and having a plurality of second touch pads disposed in the second direction and extending in the first direction,
wherein a third input signal is applied to one of the second touch pads of each second touch pad group, a fourth input signal is applied to the second touch pads not receiving the third input signal, the second touch pads disposed at the same position in the respective second touch pad groups are connected in common with a corresponding one of a plurality of second channels, and the second touch pads receiving the third input signal are respectively connected with the second channels.

5. A touch panel, comprising:
a plurality of first electrodes disposed in a first direction and extending in a second direction; and
a plurality of second electrodes each disposed between the first electrodes and extending in the second direction,
wherein the second electrodes each have a plurality of touch pads disposed in the second direction and a plurality of connection pads connecting the touch pads, one end of each first electrode is connected with a first connection line, the first connection line is connected between a first transmission channel and a first reception channel, one end of each second electrode is connected with a second transmission channel, and the other end of each second electrode is connected with a second reception channel.

6. The touch panel of claim 5, wherein the one end of each second electrode is connected with a second transmitting connection line, the other end of each second electrode is connected with a second receiving connection line, the second transmitting connection line is connected with the second transmission channel, and the second receiving connection line is connected with the second reception channel.

7. The touch panel of claim 6, wherein the second transmitting connection line and the second receiving connection line are formed of a material having high conductivity.

8. The touch panel of claim 5, wherein the second transmitting channel includes a second odd transmission channel and a second even transmission channel, the second receiving channel includes a second odd reception channel and a second even reception channel, one end of each odd-numbered second electrode among the second electrodes is connected with a second odd transmitting connection line, the other end is connected with a second odd receiving connection line, one end of each even-numbered second electrode among the second electrodes is connected with a second even transmitting connection line, the other end is connected with a second even receiving connection line, the second odd transmitting connection line is connected with the second odd transmission channel, the second odd receiving connection line is connected with the second odd reception channel, the second even transmitting connection line is connected with the second even transmission channel, and the second even receiving connection line is connected with the second even reception channel.

9. The touch panel of claim 8, wherein the second odd transmitting connection line, the second even transmitting connection line, the second odd receiving connection line and the second even receiving connection line are formed of a material having high conductivity.

10. The touch panel of claim 5, wherein there are a plurality of the second transmission channels and a plurality of the second reception channels, the one end of each second electrode is connected with a corresponding one of the second transmission channels, and the other end of each second electrode is connected with a corresponding one of the second reception channels.

11. The touch panel of claim 5, wherein the first connection line has a greater resistance than the first electrodes.

12. An input device, comprising:
a touch panel having a plurality of first touch pads disposed in a first direction and extending in a second direction and a plurality of first touch pad groups respectively disposed adjacent to the first touch pads in the first direction and having a plurality of second touch pads disposed in the first direction and extending in the second direction, and in which the first touch pads are respectively connected with corresponding first channels among a plurality of first channels and the second touch pads disposed at the same position in the respective first touch pad groups are connected in common with a corresponding one of a plurality of second channels; and
a touch sensor unit for detecting whether or not the respective first touch pads are touched through the first channels and outputting a plurality of first touch signals indicating the touched first touch pad group in a first search mode operation, and detecting whether or not the second touch pads are touched through the second channels and outputting a plurality of second touch signals indicating a touched position in the first touch pad groups in a second search mode operation.

13. The input device of claim 12, wherein, in the touch panel, the first touch pad groups are respectively disposed on one side of the first touch pads.

14. The input device of claim 12, wherein, in the touch panel, the first touch pads are respectively disposed in the corresponding first touch pad groups.

15. The input device of claim 12, wherein the touch sensor unit performs the first search mode operation and the second search mode operation in sequence.

16. The input device of claim 12, wherein the touch sensor unit simultaneously performs the first search mode operation and the second search mode operation.

17. The input device of claim 12, wherein the touch sensor unit includes:
a first touch sensor connected with the first channels, detecting whether or not the first touch pads are touched and outputting the first touch signals in the first search mode operation; and
a second touch sensor connected with the second channels, detecting whether or not the second touch pads are touched and outputting the second touch signals in the second search mode operation.

18. The input device of claim 17, wherein the first touch sensor detects impedances of the first touch pads varying according to whether or not the first touch pads are touched and determines whether or not the first touch pads are touched, and the second touch sensor detects impedances of the second touch pads varying according to whether or not the second touch pads are touched and determines whether or not the second touch pads are touched.

19. The input device of claim 18, wherein the first touch sensor outputs the first touch signals indicating that only one of the first touch pads having the lowest impedance is touched.

20. The input device of claim 17, wherein the first touch sensor includes:
a first input signal generator for generating a first input signal;
a plurality of first sensing signal generators respectively connected with the first channels, receiving the first input signal, and delaying the first input signal according to whether or not the respective first touch pads are touched to respectively output a plurality of corresponding first sensing signals;
a first reference signal generator for receiving the first input signal and outputting a first reference signal; and
a plurality of first touch signal generators for detecting delay differences between the respective corresponding first sensing signals and the first reference signal to determine whether or not the respective first touch pads are touched, and respectively outputting the corresponding first touch signals.

21. The input device of claim 20, wherein the first touch sensor outputs the first touch signals indicating that only the first touch pad corresponding to the first sensing signal having the largest delay difference from a first reference signal is touched.

22. The input device of claim 20, wherein the second touch sensor includes:
a second input signal generator for generating a second input signal;
a plurality of second sensing signal generators respectively connected with the second channels, receiving the second input signal, and delaying the second input signal according to whether or not the respective second touch pads are touched to respectively output a plurality of corresponding second sensing signals;
a second reference signal generator for receiving the second input signal and outputting a second reference signal; and
a plurality of second touch signal generators for detecting delay differences between the respective corresponding second sensing signals and the second reference signal to determine whether or not the respective second touch pads are touched, and respectively outputting the corresponding second touch signals.

23. The input device of claim 12, further comprising:
a calculator for receiving the first touch signals and the second touch signals, calculating a touch position, and outputting a coordinate code corresponding to the touch position.

24. The input device of claim 23, wherein, when there are a plurality of the touch positions, the calculator calculates the middle of the touch positions and outputs the coordinate code corresponding to the middle.

25. The input device of claim 12, further comprising:
a calculator for successively receiving the second touch signals, comparing the successively-received second touch signals to detect a movement direction, and outputting scroll information.

26. The input device of claim 12, wherein the touch panel further includes:
a plurality of third touch pads disposed in the second direction and extending in the first direction; and
a plurality of second touch pad groups disposed adjacent to the respective third touch pads in the second direction and having a plurality of fourth touch pads disposed in the second direction and extending in the first direction,
wherein the third touch pads are respectively connected with corresponding third channels among a plurality of third channels, and the fourth touch pads disposed at the same position in the respective second touch pad groups are connected in common with a corresponding one of a plurality of fourth channels.

27. The input device of claim 26, wherein, in the touch panel, the second touch pad groups are respectively disposed on one side of the third touch pads.

28. The input device of claim 26, wherein, in the touch panel, the third touch pads are respectively disposed in the corresponding second touch pad groups.

29. The input device of claim 26, wherein the touch sensor unit additionally detects whether or not the respective third touch pads are touched through the third channels and additionally outputs a plurality of third touch signals indicating the touched second touch pad group in the first search mode operation, and additionally detects whether or not the fourth touch pads are touched through the fourth channels and additionally outputs a plurality of fourth touch signals indicating a touched position in the second touch pad groups in the second search mode operation.

30. The input device of claim 29, further comprising:
a calculator for receiving the first touch signals and the second touch signals to calculate a touch position in the first direction, receiving the third touch signals and the fourth touch signals to calculate a touch position in the second direction, and outputting a coordinate code corresponding to the touch position in the first direction and the touch position in the second direction.

31. The input device of claim 26, wherein the touch sensor unit includes:
a third touch sensor for detecting whether or not the respective third touch pads are touched through the respective third channels and outputting a plurality of third touch signals indicating the touched second touch pad group in the first search mode operation; and
a fourth touch sensor for detecting whether or not the fourth touch pads are touched through the fourth channels and outputting a plurality of fourth touch signals indicating a touched position in the second touch pad groups in the second search mode operation.

32. The input device of claim 31, further comprising:
a calculator for receiving the first touch signals and the second touch signals to calculate a touch position in the first direction, receiving the third touch signals and the fourth touch signals to calculate a touch position in the second direction, and outputting a coordinate code corresponding to the touch position in the first direction and the touch position in the second direction.

33. An input device, comprising:
a touch panel having a plurality of first touch pad groups disposed in a first direction and having a plurality of first touch pads disposed in the first direction and extending in a second direction, and in which the first touch pads disposed at the same position in the respective first touch pad groups are connected in common with a corresponding one of a plurality of first channels, a first input signal is applied to one of the first touch pads in each first touch pad group, and the first touch pads receiving the first input signal are respectively connected with the first channels; and
a touch sensor unit for outputting the first input signal to the touch panel, detecting whether or not the respective first touch pads receiving the first input signal are touched through the first channels and outputting first touch signals indicating the touched first touch pad group in a first search mode operation, and detecting whether or not the first touch pads are touched through the first channels and outputting second touch signals indicating a touched position in the first touch pad groups in a second search mode operation.

34. The input device of claim 33, wherein the touch sensor unit includes:
a first touch sensor for outputting the first input signal, detecting whether or not the first touch pads receiving the first input signal are touched through the first channels and outputting the first touch signals in the first search mode operation; and
a second touch sensor for determining whether or not the first touch pads are touched through the first channels and outputting the second touch signals in the second search mode operation.

35. The input device of claim 34, wherein the second touch sensor determines whether or not the first touch pads are touched by detecting impedances of the first touch pads varying according to whether or not the first touch pads are touched.

36. The input device of claim 34, wherein the first touch sensor includes:
a first input signal generator for outputting the first input signal; and
a plurality of first touch signal generators for receiving the first input signal and a plurality of corresponding first delay signals respectively input through the plurality of first channels, detecting delay differences between the first input signal and the respective corresponding first delay signals to determine whether or not the first touch pads are touched, and outputting the corresponding first touch signals.

37. The input device of claim 36, wherein the first touch sensor outputs the first touch signals indicating that only the first touch pad corresponding to the first delay signal having the largest delay difference from the first input signal is touched.

38. The input device of claim 36, wherein the first touch signal generators each include:
a delay signal detector for receiving the corresponding first delay signal, detecting a level of the corresponding first delay signal, and outputting a pulse delay signal; and
a comparator for receiving the first input signal and the pulse delay signal, detecting a delay difference between the first input signal and the pulse delay signal to determine whether or not the corresponding first touch pad is touched, and outputting the corresponding first touch signal.

39. The input device of claim 34, wherein the second touch sensor includes:
a second input signal generator for generating a second input signal;
a plurality of second sensing signal generators respectively connected with the first channels, receiving the second input signal, and delaying the second input signal according to whether or not the respective first touch pads are touched to respectively output a plurality of corresponding second sensing signals;
a second reference signal generator for receiving the second input signal and outputting a second reference signal; and
a plurality of second touch signal generators for detecting delay differences between the respective corresponding second sensing signals and the second reference signal to determine whether or not the respective first touch pads are touched, and respectively outputting the corresponding second touch signals.

40. The input device of claim 34, wherein the touch sensor unit further includes:
a controller for outputting a control signal driving the first touch sensor in the first search mode operation and driving the second touch sensor in the second search mode operation.

41. The input device of claim 33, further comprising:
a calculator for receiving the first touch signals and the second touch signals, calculating a touch position, and outputting a coordinate code corresponding to the touch position.

42. The input device of claim 41, wherein, when there are a plurality of the touch positions, the calculator calculates the middle of the touch positions and outputs the coordinate code corresponding to the middle.

43. The input device of claim 33, further comprising:
a calculator for successively receiving the second touch signals, comparing the successively-received second touch signals to detect a movement direction, and outputting scroll information.

44. The input device of claim 33, wherein the touch panel further has a plurality of second touch pad groups disposed in the second direction and having a plurality of second touch pads disposed in the second direction and extending in the first direction, the second touch pads disposed at the same position in the respective second touch pad groups are connected in common with a corresponding one of a plurality of second channels, a third input signal is applied to one of the second touch pads in each second touch pad group, and the second touch pads receiving the third input signal are respectively connected with the second channels.

45. The input device of claim 44, wherein the touch sensor unit includes:
a touch sensor for additionally outputting the third input signal to the touch panel, additionally detecting whether or not the second touch pads receiving the third input signal are touched through the second channels and additionally outputting third touch signals indicating the touched second touch pad group in the first search mode operation, and detecting whether or not the second touch pads are touched through the second channels and outputting fourth touch signals indicating a touched position in the second touch pad groups in the second search mode operation.

46. The input device of claim 45, further comprising:
a calculator for receiving the first touch signals and the second touch signals to calculate a touch position in the first direction, receiving the third touch signals and the fourth touch signals to calculate a touch position in the second direction, and outputting a coordinate code corresponding to the touch position in the first direction and the touch position in the second direction.

47. The input device of claim 44, wherein the touch sensor unit further includes:
a third touch sensor for outputting the third input signal, detecting whether or not the respective second touch pads receiving the third input signal are touched through the second channels and outputting a plurality of third touch signals indicating the touched second touch pad group in the first search mode operation; and
a fourth touch sensor for detecting whether or not the second touch pads are touched through the second channels and outputting a plurality of fourth touch signals indicating a touched position in the second touch pad groups in the second search mode operation.

48. The input device of claim 47, further comprising:
a calculator for receiving the first touch signals and the second touch signals to calculate a touch position in the first direction, receiving the third touch signals and the fourth touch signals to calculate a touch position in the second direction, and outputting a coordinate code corresponding to the touch position in the first direction and the touch position in the second direction.

49. The input device of claim 33, wherein a second input signal is applied to the first touch pads not receiving the first input signal, and the touch sensor unit outputs the first input signal and the second input signal, determines whether or not the respective first touch pads are touched through the first channels and outputs the second touch signals in the second search mode operation.

50. The input device of claim 49, wherein the touch sensor unit includes:
an input signal generator for outputting an input signal;
a controller for receiving the input signal, outputting the input signal as the first input signal in the first search mode operation, outputting the input signal as the first input signal and the second input signal in the second search mode operation, and outputting a control signal;
a plurality of touch signal generators respectively connected with the first channels, receiving the input signal and a plurality of corresponding delay signals input through the first channels, detecting delay differences between the input signal and the respective corresponding delay signals to determine whether or not the first touch pads are touched, and outputting a plurality of corresponding touch signals; and
an output unit for receiving the touch signals, and in response to the control signal, outputting the touch signals as the first touch signals in the first search mode operation and as the second touch signals in the second search mode operation.

51. The input device of claim 50, wherein, in the first search mode operation, the touch sensor unit outputs the first touch signals indicating that only the first touch pad corresponding to the delay signal having the largest delay difference from the input signal is touched.

52. The input device of claim 50, wherein the touch signal generators each include:
a delay signal detector for receiving the corresponding delay signal, detecting a level of the corresponding delay signal, and outputting a pulse delay signal; and
a comparator for receiving the input signal and the pulse delay signal, detecting a delay difference between the input signal and the pulse delay signal to determine whether or not the corresponding first touch pad is touched, and outputting the corresponding touch signal among the touch signals.

53. The input device of claim 49, further comprising:
a calculator for receiving the first touch signals and the second touch signals, calculating a touch position, and outputting a coordinate code corresponding to the touch position.

54. The input device of claim 53, wherein, when there are a plurality of the touch positions, the calculator calculates the middle of the touch positions and outputs the coordinate code corresponding to the middle.

55. The input device of claim 49, further comprising:
a calculator for successively receiving the second touch signals, comparing the successively-received second touch signals to detect a movement direction, and outputting scroll information.

56. The input device of claim 49, wherein the touch panel further has a plurality of second touch pad groups disposed in the second direction and having a plurality of second touch pads disposed in the second direction and extending in the first direction, a third input signal is applied to one of the second touch pads in each second touch pad group, a fourth input signal is applied to the second touch pads not receiving the third input signal, the second touch pads disposed at the same position in the respective second touch pad groups are connected in common with a corresponding one of a plurality of second channels, and the second touch pads receiving the third input signal are respectively connected with the second channels.

57. The input device of claim 56, wherein the touch sensor unit additionally outputs the third input signal to the touch panel, additionally detects whether or not the second touch pads receiving the third input signal are touched through the second channels and additionally outputs a plurality of third touch signals indicating the touched second touch pad group in the first search mode operation, and additionally outputs the third input signal and the fourth input signal to the touch panel, additionally detects whether or not the second touch pads are touched through the second channels and outputs a plurality of fourth touch signals indicating a touched position in the second touch pad groups in the second search mode operation.

58. The input device of claim 57, further comprising:
a calculator for receiving the first touch signals and the second touch signals to calculate a touch position in the first direction, receiving the third touch signals and the fourth touch signals to calculate a touch position in the second direction, and outputting a coordinate code corresponding to the touch position in the first direction and the touch position in the second direction.

59. The input device of claim 56, wherein the touch sensor unit further includes:
a second touch sensor for outputting the third input signal, detecting whether or not the respective second touch pads receiving the third input signal are touched through the second channels and outputting a plurality of third touch signals indicating the touched second touch pad group in the first search mode operation, and outputting the third input signal and the fourth input signal, detecting whether or not the respective second touch pads are touched through the second channels and outputting a plurality of fourth touch signals indicating a touched position in the second touch pad groups in the second search mode operation.

60. The input device of claim 59, further comprising:
a calculator for receiving the first touch signals and the second touch signals to calculate a touch position in the first direction, receiving the third touch signals and the fourth touch signals to calculate a touch position in the second direction, and outputting a coordinate code corresponding to the touch position in the first direction and the touch position in the second direction.

61. An input device, comprising:
a touch panel having a plurality of first electrodes disposed in a first direction and extending in a second direction and a plurality of second electrodes each disposed between the first electrodes and extending in the second direction, and in which the second electrodes each have a plurality of touch pads disposed in the second direction and a plurality of connection pads connecting the touch pads, one end of each first electrode is connected with a first connection line, the first connection line is connected between a first transmission channel and a first reception channel, one end of each second electrode is connected with a second transmission channel, and the other end of each second electrode is connected with a second reception channel;
a first touch sensor unit for outputting a first input signal through the first transmission channel, detecting a first delay difference between the first input signal and a first delay signal input through the first reception channel and outputting a first coordinate in a first search mode operation; and
a second touch sensor unit for outputting a second input signal through the second transmission channel, detecting a second delay difference between the second input signal and a second delay signal input through the second reception channel, and outputting a second coordinate in a second search mode operation.

62. The input device of claim 61, wherein, in the touch panel, the one end of each second electrode is connected with a second transmitting connection line, the other end of each second electrode is connected with a second receiving connection line, the second transmitting connection line is connected with the second transmission channel, and the second receiving connection line is connected with the second reception channel.

63. The input device of claim 62, wherein the second transmitting connection line and the second receiving connection line are formed of a material having high conductivity.

64. The input device of claim 62, wherein, in the first search mode operation, the first touch sensor unit outputs a first additional input signal through the first reception channel, receives a first additional delay signal input through the first transmission channel, detects a first additional delay difference between the first additional input signal and the first additional delay signal, and outputs the first coordinate using the first delay difference and the first additional delay difference.

65. The input device of claim 64, wherein, in the second search mode operation, the second touch sensor unit outputs a second additional input signal through the second reception channel, receives a second additional delay signal input through the second transmission channel, detects a second additional delay difference between the second additional input signal and the second additional delay signal, and outputs the second coordinate using the second delay difference and the second additional delay difference.

66. The input device of claim 65, wherein the first search mode operation and the second search mode operation are performed in sequence.

67. The input device of claim 65, wherein the first search mode operation and the second search mode operation are simultaneously performed.

68. The input device of claim 61, wherein, in the touch panel, the second transmission channel includes a second odd transmission channel and a second even transmission channel, the second reception channel includes a second odd reception channel and a second even-number reception channel, one end of each odd-numbered second electrode is connected with a second odd transmitting connection line, the other end of each odd-numbered second electrode is connected with a second odd receiving connection line, one end of each even-numbered second electrode is connected with a second even transmitting connection line, the other end of each even-numbered second electrode is connected with a second even receiving connection line, the second odd transmitting connection line is connected with the second odd transmission channel, the second odd receiving connection line is connected with the second odd reception channel, the second even transmitting connection line is connected with the second even transmission channel, and the second even receiving connection line is connected with the second even reception channel.

69. The input device of claim 68, wherein the second odd transmitting connection line, the second even transmitting connection line, the second odd receiving connection line and the second even receiving connection line are formed of a material having high conductivity.

70. The input device of claim 68, wherein the second touch sensor unit includes:
a second odd touch sensor for outputting a second odd input signal through the second odd transmission channel, receiving a second odd delay input signal through the second odd reception channel, detecting a delay difference between the second odd input signal and the second odd delay input signal, and outputting a second odd coordinate;
a second even touch sensor for outputting a second even input signal through the second even transmission channel, receiving a second even delay input signal through the second even reception channel, detecting a delay difference between the second even input signal and the second even delay input signal, and outputting a second even coordinate; and
an output unit for receiving the second odd coordinate and the second even coordinate and outputting the middle of the second odd coordinate and the second even coordinate as the second coordinate.

71. The input device of claim 61, wherein there are a plurality of the second transmission channels and a plurality of the second reception channels in the touch panel, the one end of each second electrode is connected with a corresponding one of the second transmission channels, and the other end of each second electrode is connected with a corresponding one of the second reception channels.

72. The input device of claim 71, wherein, in the second search mode operation, the second touch sensor unit outputs the second input signal through the second transmission channel corresponding to the first coordinate among the second transmission channels and receives the second delay signal through the second reception channel corresponding to the first coordinate among the second reception channels.

73. The input device of claim 72, wherein, in the first search mode operation, the first touch sensor unit outputs a first additional input signal through the first reception channel, receives a first additional delay signal input through the first transmission channel, detects a first additional delay difference between the first additional input signal and the first additional delay signal, and outputs the first coordinate using the first delay difference and the first additional delay difference.

74. The input device of claim 72, wherein, in the second search mode operation, the second touch sensor unit outputs a second additional input signal through the second reception channel corresponding to the first coordinate, receives a second additional delay signal input through the second transmission channel corresponding to the first coordinate, detects a second additional delay difference between the second additional input signal and the second additional delay signal, and outputs the second coordinate using the second delay difference and the second additional delay difference.

75. The input device of claim 61, wherein the first connection line has a greater resistance than the first electrodes.
